(19) United States
(12) Patent Application Publication
(10) Pub. No.: US 2015/0332151 A1
(43) Pub. Date: Nov. 19, 2015

(54) Methods and Software For Determining An Optimal Combination Of Therapeutic Agents For Inhibiting Pathogenesis Or Growth Of A Cell Colony, And Methods Of Treating One Or More Cell Colonies

(71) Applicant: Carnegie Mellon University, Pittsburgh, PA (US)

(72) Inventors: Radu Marculescu, Pittsburgh, PA (US); Guopeng Wei, Pittsburgh, PA (US)

(21) Appl. No.: 14/711,445

(22) Filed: May 13, 2015

Related U.S. Application Data
(60) Provisional application No. 61/996,649, filed on May 13, 2014.

(51) Int. Cl. G06N 5/04; G06N 7/00

(52) U.S. Cl. CPC G06N 5/04; G06N 7/005

(57) ABSTRACT

Methods of determining a therapy for inhibiting growth or pathogenesis of one or more cell colonies based on modeling intracellular and/or intercellular communication mechanisms utilized by the cell type(s) in question, selective pressures on the one or more cell colonies within a cell population, and therapies or therapeutic agents available to a user. A dynamic molecular-level model of a cell population representing one or more cell colonies models differing aspects of one or more resistance forming mechanisms and the effects that the available treatment agents or therapies may have on the differing aspects. The dynamic molecular-model, in combination with a selective pressure model, formulates an optimization problem that is solved to determine amounts of the differing treatment agents or therapies.

### RELATED APPLICATION DATA

This application claims the benefit of priority of U.S. Provisional Patent Application Ser. No. 61/996,649, filed on May 13, 2014, and titled “Method for selecting therapeutic agents for treatment of bacterial infections,” which is incorporated by reference herein in its entirety.

### STATEMENT REGARDING FEDERALLY SPONSORED RESEARCH AND DEVELOPMENT

This invention was made, in part, with government support under Grant No. CPS-1135850 awarded by the National Science Foundation. The United States government may have certain rights in this invention.

### FIELD OF THE INVENTION

The present disclosure generally relates to the field of therapies for treating against the negative effects and diseases produced by biological cell colonies. In particular, the present disclosure is directed to methods and software for determining an optimal combination of therapeutic agents for inhibiting pathogenesis or growth of a cell colony, and methods of treating one or more cell colonies.

### BACKGROUND

Virulent biological cells that are detrimental to life, such as pathogenic cells, cells infected by viruses or prions and cancer cells, often develop resistance to therapeutic agents that can kill the cells or otherwise prevent them from communicating and generating negative effects like virulence or uncontrolled reproduction. Typically, resistance to therapeutic agents develops when colonies of such resistant mutant cells become large enough due to resistance-forming mechanisms that foster development of resistant mutant cells to a point at which the therapeutic agent(s) is/are no longer effective in inhibiting the pathogenesis or cell growth of the cell colony. Examples of resistance-forming mechanisms include multidrug efflux pump in bacterial pathogen colonies and AXL protein and ErbB epithelial growth factor mechanisms in cancer cell colonies. Researchers have developed and continue to develop various therapeutic agents, or “inhibitors,” for inhibiting the virulent expression of infectious pathogens or cell growth in tumors. Examples of inhibitors include quorum sensing inhibitors that attack signal production, signal accumulation, and/or signal reception components of quorum sensing mechanisms and AXL and ErbB inhibitors that target AXL and ErbB mechanisms, respectively. However, research has shown that virulent cell colonies can also develop resistances to inhibitors, thereby complicating treatment of the human or other hosts afflicted with a virulent cell colony.

### SUMMARY OF THE DISCLOSURE

In one implementation, the present disclosure is directed to a method of generating a therapy recommendation for inhibiting pathogenesis or growth of one or more cell colonies, wherein the therapy includes a plurality of differing therapeutic agents, the method performed by a computing system and comprises receiving an indication of one or more types of cells in the one or more cell colonies; solving an optimization problem to generate at least a portion of a therapy recommendation specifying relative amounts of the plurality of differing therapeutic agents to administer in combination with one another, wherein the optimization problem includes accounting for a dynamic molecular-level model that models 1) a cell population representing the one or more cell colonies, 2) differing components of one or more resistance-forming mechanisms of the one or more types of cells, and 3) effects that the differing therapeutic agents have on the differing components; and accounting for a selective-pressure model configured to assess probabilities of inducing selective pressure on the cell population; and providing or applying the therapy recommendation to a user, wherein the therapy recommendation is based on the relative amounts of the plurality of differing therapeutic agents.

In another implementation, the present disclosure is directed to a machine-readable storage medium containing machine-executable instructions for performing a method of generating a therapy recommendation for inhibiting pathogenesis or growth of one or more cell colonies, wherein the therapy includes a plurality of differing therapeutic agents, the method performed by a computing system. The machine-executable instructions comprises a first set of machine-executable instructions for receiving an indication of one or more types of cells in the one or more cell colonies; a second set of machine-executable instructions for solving an optimization problem to generate at least a portion of a therapy recommendation specifying relative amounts of the plurality of differing therapeutic agents to administer in combination with one another, wherein the optimization problem includes accounting for a dynamic molecular-level model that models 1) a cell population representing the one or more cell colonies, 2) differing components of one or more resistance-forming mechanisms of the one or more types of cells, and 3) effects that the differing therapeutic agents have on the differing components; and accounting for a selective-pressure model configured to assess probabilities of inducing selective pressure on the cell population; and a third set of machine-executable instructions for providing or applying the therapy recommendation to a user, wherein the therapy recommendation is based on the relative amounts of the plurality of differing therapeutic agents.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating an exemplary method of determining a combination of differing therapeutic agents for inhibiting growth of a cell colony;

FIG. 2 is a flow diagram illustrating an exemplary method of generating a therapy recommendation for inhibiting the pathogenesis or the growth of a cell colony;

FIG. 3 is a high-level block diagram illustrating an exemplary pathogen therapy system that may be used to implement one or more of the methods of FIGS. 1 and 2;

FIG. 4 is an illustration of an example of bacterial quorum sensing in accordance with aspects of the invention;

FIG. 5 is an illustration of an example of a pathogen quorum sensing system and virulence expression in accordance with aspects of the invention;

FIG. 6A is a graph of average intercellular autoinducer (AI) concentration vs. time for a control group without inhibition in accordance with aspects of the invention;

FIG. 6B is a graph of virulence concentration vs. time for a control group without inhibition in accordance with aspects of the invention;

FIG. 6C is a graph of spatial distribution for a control group without inhibition in accordance with aspects of the invention;

FIG. 7A is a graph of average intracellular AI concentration vs. time for individual quorum sensing inhibitors (QSIs) in accordance with aspects of the invention;

FIG. 7B is graph of average intracellular LasR concentration vs. time for individual QSIs in accordance with aspects of the invention;

FIG. 7C is a graph of virulence concentration vs. time for individual QSIs in accordance with aspects of the invention;

FIG. 8A is a graph of virulence concentration vs. time for repeated use of a single QSI in accordance with aspects of the invention;

FIG. 8B is a graph of mutant cell count vs. time for repeated use of a single QSI in accordance with aspects of the invention;

FIG. 9 is a graph of virulence concentration vs. time for a case study in accordance with aspects of the invention;

FIG. 10 is an illustration of a quorum sensing regulatory network for gram-negative bacteria in accordance with aspects of the invention;

FIG. 11 is illustrates two types of one species of bacteria and a graph of chemical signal concentration in accordance with aspects of the invention;

FIG. 12 illustrates three different layers of biofilm in accordance with aspects of the invention;

FIG. 13 illustrates a varying steps of the cluster formation process in accordance with aspects of the invention;

FIG. 14 illustrates both a bacterial growth in a control group and a bacterial growth with a targeted probiotic treatment taken at different times in accordance with aspects of the invention;

FIG. 15 is a graph of the number of cells over time for a control group, targeted intervention group and a non-targeted intervention group in accordance with aspects of the invention;

FIG. 16A is a graph of virulence production vs. time in accordance with aspects of the invention;

FIG. 16B is a graph of average thickness vs. time in accordance with aspects of the invention;

FIG. 16C is a graph of the percentage of networked cells vs. time in accordance with aspects of the invention;

FIG. 16D is a graph of the number of communities vs. time in accordance with aspects of the invention;

FIG. 16E is a graph of the clustering coefficient vs. time in accordance with aspects of the invention;

FIG. 16F is graph of the number of network links vs. time in accordance with aspects of the invention; and

FIG. 17 is a diagrammatic view of a computing system suitable for use in executing aspects of the present invention.

### DETAILED DESCRIPTION

In some aspects, the present disclosure is directed to methods of determining combinations of therapeutic agents for inhibiting the pathogenesis or the growth of one or more cell colonies by solving an optimization problem formulated from a combination of 1) a dynamic molecular-level model of a cell population representing behaviors of the one or more cell colonies and 2) a selective-pressure model that assesses the probabilities of inducing selective pressures on cell colonies within the cell population. The present inventors have discovered a method for determining the appropriate mix of therapeutic agents to administer to a patient based on modeling communication behavior of at least one cell colony within a population of cells and also based on modeling metabolism and the probability of the inducement of selective pressure on at least a cell colony of a cell population that may lead towards increased drug resistance. This discovery minimizes the likelihood that a particular cell colony will develop resistances to the therapeutic agents, which allows the therapy to be more effective in inhibiting the pathogenesis or the growth of the colony. As those skilled in the art will appreciate, such methods can be used for a variety of types of biological cells, such as pathogen cells, cells infected by viruses, prions, or cancer cells. The dynamic molecular-level model accounts for one or more resistance-forming mechanisms relevant to the cells at issue in the colony and the effect(s) that each of a plurality of differing therapeutic agents has on the resistance-forming mechanism(s), and the selective-pressure model assesses the probabilities of inducing selective pressures on one or more cell populations. The result of the optimization is a specific combination, in terms of relative amounts, or ratio, of the plurality of therapeutic agents for administering to the cell colony, for example, via an afflicted human or other host. The detailed examples below provide not only a complete example in the context of quorum sensing suppression in particular strains of bacteria but also details on considerations for generating the appropriate models for the optimization problem.

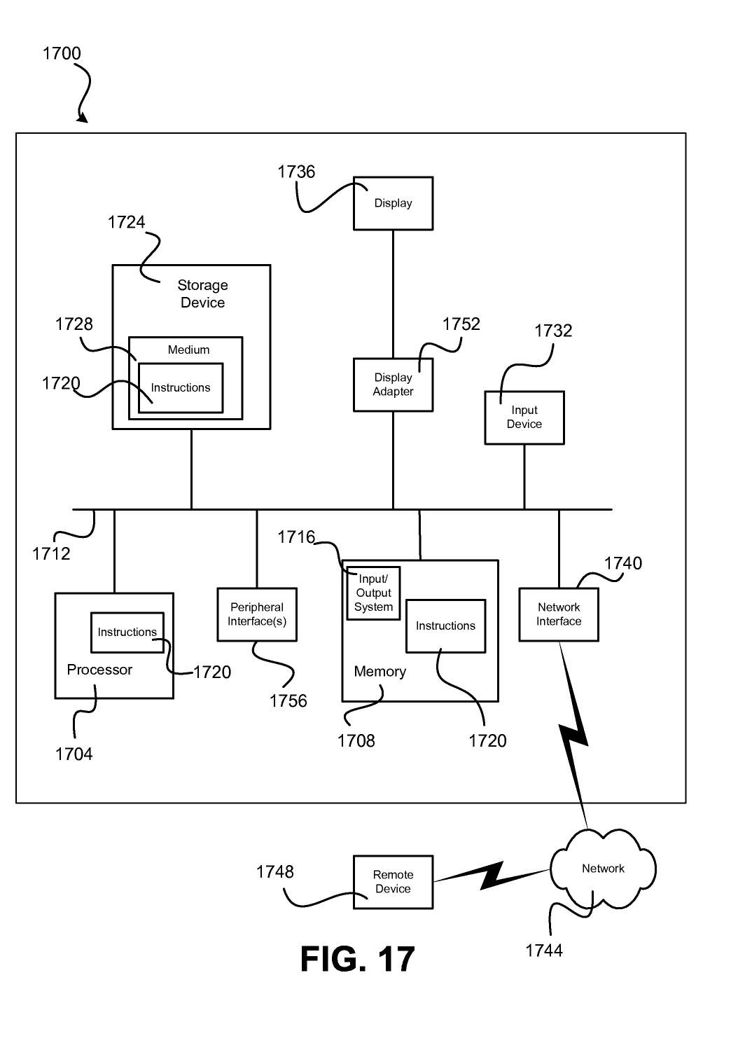

Those skilled in the art will understand that the basic methods disclosed herein can be used in a wide variety of applications. For example, disclosed methods can be used to inform treatment plans that are personalized for individual patients based on the characteristics of their particular infection and/or cancer. As another example, disclosed methods can be used to inform treatment plans that are formulated to treat particular types of pathogens and/or cancer. As a further example, disclosed methods can be used as part of a screening program for identifying compounds, classes of compounds, and/or libraries of compounds to find new and improved therapeutic agents that can be used as therapeutics, or as antibacterial or anti-biofilm materials, coatings, or compounds, among others. As those skilled in the art will also understand, the optimization problem is typically computer-implemented, for example being executed and solved by a computing system, such as the computing system 1700 illustrated in FIG. 17. Such a computing system may be any suitable computing system, such as a laptop computer, desktop computer, tablet computer, smartphone, web server, mainframe computer, homogeneous or heterogeneous multiprocessor platform, any CPU/FPGA/GPU-based platform, and any meaningful combination thereof, among others. Fundamentally, there are no limitations on the type and nature of the computing system used to implement methods of the present disclosure, except that it can be programmed or otherwise configured to execute the requisite algorithms.

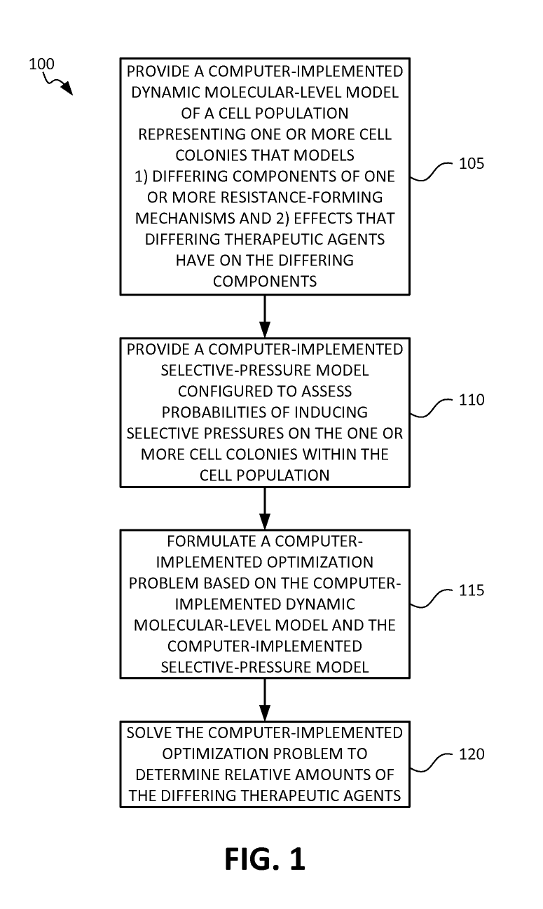

Referring now to the drawings, FIG. 1 illustrates an exemplary method 100 of determining a combination of differing therapeutic agents for inhibiting growth of a cell colony. As noted above, method 100 is applicable to a variety of cell types. In addition, those skilled in the art will readily appreciate, for example, that many bacterial infections are composed of more than one type of bacteria, some or all of which may be harmful to the host. Method 100 can be adapted to handle virtually any number of differing cell types in a particular cell population and virtually any number of differing therapeutic agents for the differing cell types and their resistance-forming mechanisms. Essentially, the only impact of modeling multiple cell types and/or a larger number of therapeutic agents will be on the complexity of the optimization problem. Other factors that can impact the complexity of the optimization problem are the number of resistance-forming mechanisms and/or component(s) of such mechanism(s) modeled, among others. The optimization problem may include a dynamic molecular-level model that may be optimized to account for competition, cell size and mass, cell growth, varied cell colonies, varied cell types within a particular colony(i.e., wild-types and various mutants), various kinetic parameters, signal molecule production rate, substrate affinity, autoinducer (AI) signal concentration, extracellular polymeric substance (EPS), virulence, and several other factors that will be readily appreciated by a person of ordinary skill in the art after reading this disclosure in its entirety.

In the context of method 100, cells within the cell colony can develop resistance to individual ones of the differing therapeutic agents via one or more resistance-forming mechanisms, such as multidrug efflux pump in pathogen cell colonies and AXL protein and ErbB epithelial growth factor mechanisms in cancer cell colonies, among others. In addition, in method 100, differing ones of the therapeutic agents target differing components, such as signal production, signal accumulation, and/or signal reception, of the resistance-forming mechanisms. Those skilled in the art will readily appreciate that these are not the only resistance-forming mechanisms and mechanism components that method 100 can address; rather, they are merely exemplary, as it is not necessary to provide exhaustive lists, since those skilled in the art will be able to readily identify other resistance-forming mechanisms and components thereof relevant to method 100.

Step 105 includes providing a computer-implemented dynamic molecular-level model that models a cell population that represents the represents one or more cell colonies. In addition, the dynamic molecular-level model models the differing components of the one or more resistance-forming mechanisms and the effects that the differing therapeutic agents have on the differing components. In some instantiations, the dynamic molecular-level model is composed of ordinary differential equations (ODEs) for the relevant resistance-forming mechanism(s) of the cell colony and the effects of the therapeutic agents on the corresponding components of those mechanism(s). As a non-limiting example in the context of quorum sensing mechanisms, three categories (based on their mechanisms of action) of quorum sensing inhibitors (QSIs) are modeled, namely, lasR/lasI-expression inhibitors, AI formation and activity inhibitors, and LasR inhibitors, targeting the signal production, signal accumulation, and signal reception components of the quorum sensing system, respectively. As just noted, those skilled in the art will recognize that the dynamic molecular-level model could be extended to include QSIs having different mechanisms of action and inhibition of inter-cell communication.

As those skilled in the art will readily understand, a precursor to step 105 is to create a cell culture assay, or similar technique, of the cell population to determine its composition so that the cell population can be properly modeled. Such an assay may be created in any suitable manner known to those skilled in the art. Depending on the application of method, for example, clinical or laboratory, samples of the cell colony can be collected for assay in any manner known to those skilled in the art suitable for the particular application. Once the constituent cell type(s) of the cell population is/are known, another precursor to step 105 is to identify the relevant resistance-forming mechanism(s) and a corresponding set of therapeutic agents known or suspected to attack one or more components of such resistance-forming mechanism(s). Once all of the relevant information is known, a suitable dynamic molecular-level model of the system is created and then provided at step 105. A detailed example of creating a dynamic molecular-level model for use in method 100 is described below in detail to give the reader a detailed understanding of creating such a model for any suitable biological cell population or colony and set of therapeutic agents under consideration.

Step 110 includes providing a computer-implemented selective-pressure model configured to assess probabilities of inducing selective pressure(s) on the cell population of the dynamic molecular-level model that would lead toward increased resistance(s) to the identified therapeutic agents. As will be understood by those skilled in the art, the selective-pressure model is based on a categorization of the types of selective pressure created by the identified therapeutic agents. A detailed example of creating a selective-pressure model for use in method 100 is described below in detail to give the reader a detailed understanding of creating such a model for any suitable biological cell population and set of therapeutic agents under consideration.

Step 115 includes formulating a computer-implemented optimization problem from a combination of the dynamic molecular-level model of step 105 and the selective-pressure model of step 110. This optimization problem is designed to find the optimal combination of the identified therapeutic agents, while taking into consideration the selective pressures induced by the identified therapeutic agents on particular cell colonies of the cell population. As those skilled in the art will readily understand, the optimization problem may be formulated with an objective function designed to maximize the efficacy of the combined-agent therapy and constraints designed to limit the total selective pressure induced by the identified therapeutic agents in a particular environment, such as the in-situ host environment of the cell population at issue. The optimization problem may be set up for determining the relative amounts, or ratio, of the differing identified therapeutic agents in the combination. A detailed example of formulating an optimization problem in the context of quorum sensing inhibition mechanisms is described below in detail to give the reader a detailed understanding of creating such a model for any suitable biological cell population and set of therapeutic agents under consideration.

At step 120, a suitable computing system solves the optimization problem to determine the relative amounts of the differing therapeutic agents in the combination. Post-solution activity will vary depending on the application of method 100. For example, if the application is in a clinical setting, a healthcare worker can use the combination determined at step 120 to devise a multi-therapeutic agent therapy for the patient at issue. As another example, if the application of method 100 is in a research setting, a researcher can use the combination determined at step 120 to investigate efficacy and to refine modeling techniques used in further studies. As yet another example, if the application of method 100 is in a drug manufacturing setting, a worker can use the combination determined at step 120 to formulate drug/drug-delivery combinations for use in clinical settings, among many others. Some of these applications are illustrated below.

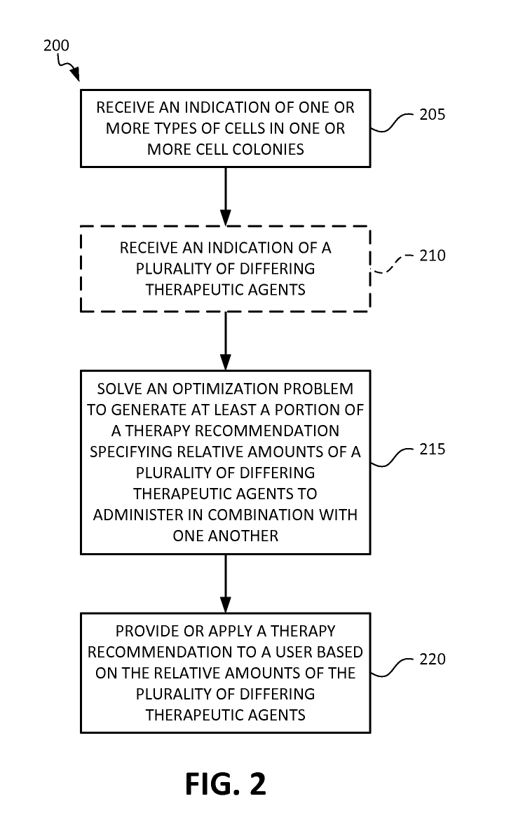

FIG. 2 illustrates a method 200 of generating a therapy recommendation for inhibiting growth of a cell population or one or more cell colonies within a cell population, wherein the therapy includes a plurality of differing therapeutic agents. Method 200 is performed by a suitably programmed computing system, such as any one of the computing systems noted elsewhere in this disclosure. At step 205, the computing system receives an indication of one or more types of cells in the cell population. Step 205 may be performed in any of a variety of ways. For example, the computing system may be configured to handle many types of cells, such as types of pathogenic cells, cells infected by viruses or prions, and cancer cells, and the computing system may present the user with a user interface (UI), such as a graphical UI (GUI), for the user to enter the type(s) of cells in the cell colony and/or genetic information (e.g., critical mutations, drug resistance genes) as determined from a suitable assay. In some embodiments, the computing system may present the user with a graphical checkbox list that allows the user to select the one or more cell types from the list. In some embodiments, the computing system may present the user with a drag-and-drop style user interface that allows the user drag an identifier (e.g., icon) representing each relevant cell type to a “selected” region. In some embodiments having automated assaying, the identification of cell type(s) may be performed automatically or automatedly, with the automated assay providing the relevant cell type(s) and/or genetic information directly to the computing device. Other manners and modes of receiving known in the art can be used at step 205.

At optional step 210, the computing system receives an indication of a plurality of differing therapeutic agents Like step 205, if step 210 is implemented it may be performed in any of a variety of ways. For example, the computing system may present the user with a UI, such as a GUI, for the user to enter the plurality of differing therapeutic agents. In some embodiments, the computing system may present the user with a graphical checkbox list that allows the user to select the therapeutic agents from the list. In some embodiments, the computing system may present the user with a drag-and-drop style user interface that allows the user drag an identifier (e.g., icon) representing each desired therapeutic agent. A user may select the therapeutic agents based on the pertinent therapeutic agents available onsite or based on another factor (e.g., patient allergies, safety issues, etc.). In some embodiments, the therapeutic agents may be selected automatedly by the computing system based on the identification of the relevant cell type(s) at step 205. Other manners and modes of receiving known in the art can be used at optional step 210.

At step 215, the computing system solves an optimization problem to determine relative amounts of the plurality of differing therapeutic agents to administer in combination with one another. In the manner described above, the optimization problem may be formulated from a dynamic molecular-level model of a cell population and a selective-pressure model. The dynamic molecular-level model of the cell population or one or more cell colonies of the cell population models differing components of one or more resistance-forming mechanisms of the one or more types of cells present in the cell population and models the effects that the differing therapeutic agents have on the differing components. The selective-pressure model is configured to assess the probabilities of inducing selective pressure on particular cell colonies within the cell population. In some embodiments, the optimization problem may be constructed automatedly from a database of preexisting models, such as a database maintained by a healthcare organization and available widely, for example, over the Internet.

At step 220, the computing system may display to the user the therapy recommendation determined at step 215. The therapy recommendation is based on the relative amounts, or ratio, of the different therapeutic agents used in the optimization problem solved at step 215. The therapy recommendation may include not only the pertinent relative amounts but also other agent-delivery information, such as frequency of administration of the combination and duration of the recommended therapy, among other information. It is also noted the therapy recommendation may also include homeopathic remedies in addition to therapeutic agents or alone. It is further noted that therapeutic agents may include probiotics. A person of ordinary skill in the biochemical arts will readily appreciate the vast number of therapeutic agents that can be used in accordance with the methods disclosed herein.

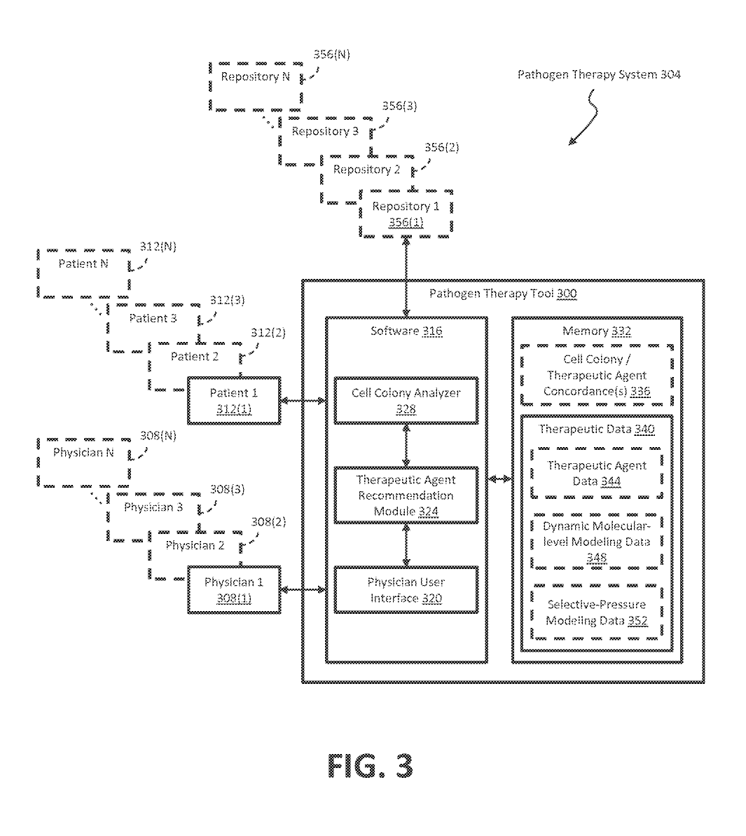

Referring now to FIG. 3, a pathogen therapy tool 300 may play a central role in a pathogen therapy system 304, which may include one or more physicians 308(1) to 308(N), such as “Physician 1” 308(1), “Physician 2” 308(2), and “Physician 3” 308(3), and up to any number of physicians (designated by “Physician N” 308(N)) who may utilize pathogen therapy tool 300 to determine a combination of differing therapeutic agents for inhibiting growth of one or more cell colonies within a cell population, for example by performing a method like that of FIG. 1, and/or to provide one or more patients 312(1) to 312(N), such as “Patient 1” 312(1), with therapy recommendations for inhibiting growth of one or more cell colonies, for example by performing a method like that of FIG. 2. As a particular non-limiting example, physicians 308(1) to 308(N) may comprise one or more doctors, other healthcare providers, and/or medical services, while patients 312(1) to 312(N) may comprise one or more human, non-human, or groups of individuals. In this example, pathogen therapy tool 300 is configured to allow physicians 308(1) to 308(N) to provide information relating to an assay that has been performed and/or perform assays on samples from one or more patients 312(1) to 312(N) in order to determine effective combinations of therapeutic agents and/or specific therapy recommendations. As such, through use of pathogen therapy tool 300, physicians 308(1) to 308(N) can generate automated therapy recommendations for groups of affected individuals and/or make better-informed decisions regarding therapeutic agents for particular individuals.

In the context of exemplary pathogen therapy tool 300 of FIG. 3, aspects of the present disclosure are implemented in software 316. One or more “blocks” of computer program code, or modules of code, may be included in software 316. It is to be understood that separate “modules” are described herein for ease of illustration and discussion. As a practical matter, the program code instantiating the invention could be organized in any one of a number of well-known manners to provide the functions described. While it is possible that separate code modules could be created to achieve the separate functions described, that is not required. So while various modules of the programs of the disclosure are described separately, in practice the actual modules of code instantiating the functions described for those separate modules could be intermingled; they do not have to be separate and independent sequences of code.

Here, software 316 includes a physician user interface 320, which physicians may access either directly by interacting with device 300 or indirectly (e.g., via an appropriately configured client, not shown), a therapeutic agent recommendation module 324 for formulating therapeutic agent recommendations from one or more inputs provided by one or more physicians 308(1) to 308(N) and/or patients 312(1) to 312(N), and a cell colony analyzer 328, which may identify one or more particular cell colonies within cell population by performing an automated assay of a patient sample and/or by analyzing descriptive information entered by a physician.

Physician user interface 320 may provide a GUI operable to allow one or more physicians 308(1) to 308(N) to provide information and/or patient samples to pathogen therapy tool 300 and/or to use the pathogen therapy tool to generate therapy recommendations and/or therapeutic agents for one or more patients 312(1) to 312(N). Additionally or alternatively, physician user interface 320 may comprise a software interface allowing each physician 308(1) to 308(N) to utilize in-house software or separate clients, in some embodiments with custom interfaces, to interact with pathogen therapy tool 300. In some embodiments, physician user interface 320 may allow pathogen therapy tool 300 to automatedly transmit and/or retrieve information from one or more physicians 308(1) to 308(N), as such may be required or desirable for determining therapy recommendations and/or therapeutic agents, such as when mass-scale therapy recommendations are generated for a plurality of patients 312(1) to 312(N).

Therapeutic agent recommendation module 324 may utilize dynamic molecular-level modeling and/or selective-pressure modeling information to automatedly determine therapy recommendations and/or therapeutic agents as a function of information and/or patient samples. In doing so, therapeutic agent recommendation module 324 may interface with cell colony analyzer 328 in order to collect information that may be necessary to make one or more of such determinations. Cell colony analyzer 328 may analyze descriptive information entered by a physician, such as Physician 1 308(1), via physician user interface 320 in order to identify cell colonies to be treated, and in some embodiments the cell colony analyzer may interface with and/or form a portion of a tool designed and configured to automatedly perform an assay on a sample collected from a patient, such as Patient 1 312(1).

Pathogen therapy tool 300 may also include a memory 332 that holds and/or stores a variety of information, including, but not limited to, cell colony/therapeutic agent concordance(s) 336 specifying one or more combinations of particular therapeutic agents suitable for treating one or more particular cell colonies and therapeutic data 340 usable for generating such one or more of such concordance(s). For example, therapeutic data 340 may include therapeutic agent data 344, dynamic molecular-level modeling data 348, and selective-pressure modeling data 352. Therapeutic data 340 may be provided by a physician, such as one or more of physicians 308(1) to 308(N), included in pathogen therapy tool 300 as factory defaults, and/or received or retrieved from a third-party service.

Notably, in some embodiments, as briefly mentioned above, therapeutic agent recommendation module 324 may automatedly determine one or more optimal therapy recommendations and/or therapeutic agents for one or more patients 312(1) to 312(N) as a function of one or more aspects of therapeutic data 340. After making one or more of such a determinations, therapeutic agent recommendation module 324 may store one or more viable cell colony/therapeutic agent concordance(s) 336 in memory 332 for future reference by pathogen therapy tool 300 or other pathogen therapy tools that may be in communication, either directly or indirectly, with the pathogen therapy tool. Further, by taking advantage of one or more cell population type(s) identified by cell colony analyzer 328, pathogen therapy tool 300, via therapeutic agent recommendation module 324, can automatically select one or more known resistance-forming mechanisms and corresponding therapeutic agents (inhibitors) and create one or more models, such as dynamic molecular-level modeling data 348 and/or selective-pressure modeling data 352.

In some embodiments, therapeutic agent recommendation module 324 may utilize therapeutic data, such as therapeutic data 340, specific to a particular user and/or environment. For example, a physician, such as Physician 1 308(1), may only have certain therapeutic agents available to them and so may need to select available therapeutic agents specifically via physician user interface 320, which may then be stored in therapeutic agent data 344, for pathogen therapy tool 300 to create the appropriate modeling. Further, in some embodiments, a physician may need to provide other information such that pathogen therapy tool 300 can perform such modeling, such as information on the host environment, which may include one or more of nutrition sources; this information may be stored in one or more appropriate portions of memory 332, as will be apparent to those of ordinary skill in the art after reading this disclosure in its entirety.

It is noted that although the various components of memory 332 are shown in FIG. 3 and described herein as separate components, they may be implemented as a single component or database. Further, in some embodiments, cell colony/therapeutic agent concordance(s) 336 may comprise a database of databases, one for each patient or group of patients 312(1) to 312(N), among myriad other implementations that will be readily apparent to one of ordinary skill in the art after reviewing this disclosure in its entirety. Memory 332 may represent any part or the entirety of the memory used by pathogen therapy tool 300 in providing its functionality. Depending upon the particular implementation at issue, memory 332 may be volatile memory, such as primary storage memory (e.g., random-access memory (RAM) or cache memory, etc.), non-volatile memory, such as secondary storage memory (e.g., a magnetic drive, optical drive, etc.) and/or cloud computing storage, and any combination thereof and in any number of memory devices. In embodiments wherein pathogen therapy tool 300 undertakes a task of automatedly collecting and storing information from one or more physicians 308(1) to 308(N) and/or third parties, memory 332 will typically be one or more secondary storage devices and/or cloud computing storage. In embodiments wherein pathogen therapy tool 300 collects data in real-time, such as from current activity in a separate third-party database or from data stores of one or more individual physicians 308(1) to 308(N) in conjunction with generating therapy recommendations and/or therapeutic agents, memory 332 may only need to be a primary memory and/or cloud computing storage. Those skilled in the art will readily understand the types of memory(ies) needed for memory 332 for any particular instantiation of a pathogen therapy tool of the present disclosure.

As mentioned above, pathogen therapy tool 300 may interface with one or more third-party services or databases in order to update those services or databases with newly determined information and/or download new information, such as new modeling data 348, 352 and/or cell colony/therapeutic agent concordances 336. Such third-party services and databases are represented in FIG. 3 as repositories 356(1) to 356(N), such as “Repository 1” 356(1), “Repository 2” 356(2), and “Repository 3” 356(3), and up to any number of repositories (designated by “Repository N” 356(N)). Repositories 356(1) to 356(N) may comprise one or more centralized and/or decentralized databases or services provided by one or more organizations, such as the United States National Institutes of Health (NIH) and/or World Health Organization (WHO), among others. Pathogen therapy tool 300 may include further user interfaces (not shown) to enable communication with one or more repositories 356(1) to 356(N).

For the sake of completeness, it is noted that the unlabeled arrows in FIG. 3 represent temporary and/or permanent data connections that enable data communication between various components of pathogen therapy tool 300. These connections may be implemented in the form of, for example, data buses, Internet connections, local network connections, and/or any other connections between electronic devices or portions of one or more devices.

Referring again to FIGS. 1 and 2, and also FIG. 3, pathogen therapy tool 300 can be used to perform one or more steps of methods 100 and 200. For example, using one or more of the various elements of pathogen therapy tool 300 described above, the pathogen therapy tool may perform any requisite preliminary steps of method 100, generate and/or receive one or more models in accordance with step 105 of the method, provide and/or receive one or more selective-pressure models in accordance with step 110, form an optimization problem from a combination of molecular-level modeling data, such as molecular-level modeling data 348, and selective-pressure modeling data, such as selective-pressure modeling data 352, in accordance with step 115, and/or solve the optimization problem to determine one or more potential cell colony/therapeutic agent concordance(s) 336. Similarly, pathogen therapy tool 300 may perform any requisite preliminary steps of method 200, generate and/or receive an indication of one or more types of cells in a cell colony in accordance with step 205 of the method, generate and/or receive an indication of a plurality of differing therapeutic agents in accordance with step 210, solve an optimization problem to determine a therapy recommendation in accordance with step 215, and/or display to a user, such as Physician 1 308(1), the therapy recommendation determined at step 215. In some embodiments, patient information regarding particular cell colonies, biofilm stages, nutrition and oxygen supply, etc., can be provided by a physician to pathogen therapy tool 300. Pathogen therapy tool 300 may then model cooperation and competition among heterogeneous bacteria strains, generate optimal combinations of antibiotics, probiotics, and quorum sensing inhibitors, and simulate various optimal candidate combinations in order to generate one or more potential cell colony/therapeutic agent concordance(s) 336. Physicians may then provide feedback to pathogen therapy tool 300 such that it can appropriately improve and/or modify one or more potential cell colony/therapeutic agent concordance(s) 336.

Before describing specific examples, several additional exemplary broad embodiments are first presented. In some exemplary additional embodiments, aspects of the present disclosure can be used to implement a method of determining a combination of differing therapeutic agents for inhibiting the pathogenesis or growth of one or more cell colonies, wherein 1) cells within the one or more cell colonies can develop resistance to individual ones of the differing therapeutic agents and 2) differing ones of the differing therapeutic agents target differing components of one or more resistance-forming mechanisms. Such a method may comprise: providing a computer-implemented dynamic molecular-level model of a cell population representing the one or more cell colonies that models 1) the differing components of the one or more resistance-forming mechanisms and 2) effects that the differing therapeutic agents have on the differing components; providing a computer-implemented selective-pressure model configured to assess probabilities of inducing selective pressures on the one or more cell colonies within the cell population; formulating a computer-implemented optimization problem based on the computer-implemented dynamic molecular-level model and the computer-implemented selective-pressure model; and solving the computer-implemented optimization problem to determine relative amounts of the differing therapeutic agents in the combination. Such a method may be performed partially or entirely automatically or automatedly by a computing system. Further, in some embodiments, a machine-readable storage medium containing machine-executable instructions for performing such a method may be provided.

Additionally or alternatively, aspects of the present disclosure can be used to implement a method of treating and/or preventing pathogenesis or growth of one or more cell colonies in a host. Such a method may comprise administering, to the host and in relative amounts relative to one another, a plurality of differing therapeutic agents designed to work in combination with one another to inhibit the pathogenesis or growth of the one or more cell colonies, wherein the relative amounts are determined by solving an optimization problem formulated from: a dynamic molecular-level model that models 1) a cell population representing the one or more cell colonies, 2) differing components of one or more resistance-forming mechanisms of the one or more types of cells, and 3) effects that the differing therapeutic agents have on the differing components; and a selective-pressure model configured to assess probabilities of inducing selective pressures on the cell population. Such a method may be performed partially or entirely automatically or automatedly by a computing system. Further, in some embodiments, a machine-readable storage medium containing machine-executable instructions for performing such a method may be provided.

Further additionally or alternatively, aspects of the present disclosure can be used to implement a method of instantiating an administrable therapy for inhibiting growth of one or more cell colonies. Such a method may comprise: receiving relative amounts of a plurality of differing therapeutic agents designed to work in combination with one another to inhibit the pathogenesis or the growth of the one or more cell colonies, wherein the relative amounts are determined by solving a computer-implemented optimization problem formulated from: a dynamic molecular-level model that models 1) a cell population representing the one or more cell colonies, 2) differing components of one or more resistance-forming mechanisms of the one or more types of cells, and 3) effects that the differing therapeutic agents have on the differing components; and a selective-pressure model configured to assess probabilities of inducing selective pressures on the cell population; and providing at least one formulation of the plurality of therapeutic agents in the relative amounts so as to instantiate the administrable therapy. Such a method may be performed partially or entirely automatically or automatedly by a computing system. Further, in some embodiments, a machine-readable storage medium containing machine-executable instructions for performing such a method may be provided.

### EXAMPLE 1

### Quorum Sensing Inhibitors For Bacteria Colonies

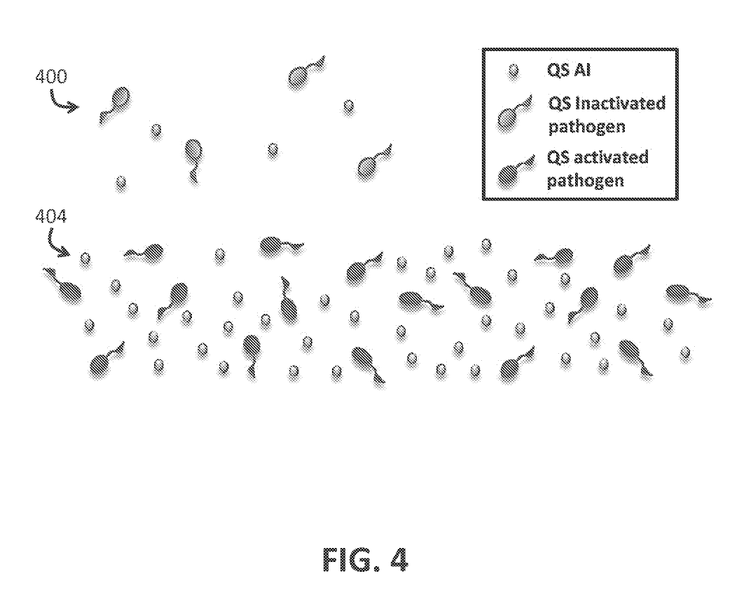

Bacteria produce hormone-like AI molecules, which can diffuse across bacteria population and accumulate over time in the extracellular environment. At the same time, bacteria can sense the surrounding AI concentration, which conveys the information about cell density, with the cytoplasmic or membrane receptors. Referring now to FIG. 4, when the population density is low, the AI molecules diffuse away and cannot accumulate as shown in upper portion 400 of the drawing. If the population density is high, then the AI concentration can reach a critical threshold value, and the bacteria population triggers a coordinated response, as shown in lower portion 404 of FIG. 4.

The regulatory network of P. aeruginosa consists of multiple interconnected signaling layers that coordinate the pathogen virulence and persistence, which pose a major threat to humans. Due to the complexity and diversity of these regulatory networks, in this example only the dominant regulatory system regulating various virulence factors, namely, the Las system, which belongs to the LuxIR family, is considered.

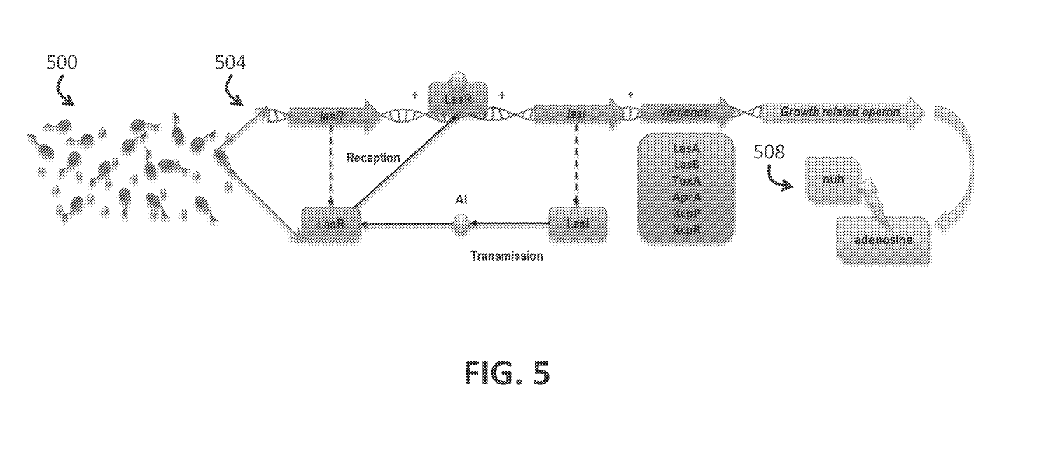

As shown in FIG. 5 at portion 500, QS enables a bacterial population to mount a unified response that is advantageous to its survival by improving access to complex nutrients or environmental niches, collective defense against other competitive microorganisms, or host defense mechanisms. The Las system produces and responds to N-3-oxo-dodecanoyl homoserine lactone, which is produced by the LasI synthase and recognized by the intracellular receptor LasR. In this case, bacteria act as both transmitters and receivers. The product of the LasR and AI binding reaction, namely, the LasR-AI complex, regulates the production of multiple virulence factors involved in acute infection and host cell damage. At portion 504, Gram-negative bacteria use largely homologous quorum-sensing networks, where the AIs are detected and regulated via genetic circuits. Specially for P. aeruginosa, LasI is an AI synthase, LasR is an AI receptor that can bind the AI molecules, and the LasR-AI complex regulates the transcription of the downstream operon. At portion 508, QS system also controls some growth related operon, such as the nucleoside hydrolase (nuh) gene which is required for bacteria to grow on adenosine. Experiments with mouse models demonstrate that the deletion of either AI synthases or AI receptors results in a decrease of the infection severity.

To illustrate an embodiment of the present invention, a mixed cell-based and ODE-based model for the cell-to-cell physical interactions and molecular dynamics of the Las system, respectively, is used. In the cell-based model, bacteria are considered as spheres of radius 1 μm. Physical volume exclusion rules are explicitly modeled, i.e., two bacteria cannot occupy the same space at the same time. The molecular network of the LasIR quorum sensing system has two feedback loops. As shown in FIG. 5, the LasR-AI complex upregulates the expression of both LasR and LasI genes. Based on ODE-models, the following equations can be used to describe the LasIR QS system:

$$\begin{matrix}\frac{d [ A ]}{d t} = {c}_{A} + \frac{{k}_{A} [ C ]}{{K}_{A} + [ C ]} - {k}_{0} [ A ] - {k}_{1} [ R ] [ A ] + {k}_{2} [ RA ] & ( 1 ) \\ \frac{d [ R ]}{d t} = {c}_{R} + \frac{{k}_{R} [ C ]}{{K}_{R} + [ C ]} - {k}_{3} [ R ] - {k}_{1} [ R ] [ A ] + {k}_{2} [ RA ] & ( 2 ) \\ \frac{d [ RA ]}{d t} = {k}_{1} [ R ] [ A ] - {k}_{2} [ RA ] - 2 {{k}_{4} [ RA ]}^{2} + 2 {k}_{5} [ C ] & ( 3 ) \\ \frac{d [ C ]}{d t} = {{k}_{4} [ RA ]}^{2} - {k}_{5} [ C ] & ( 4 )\end{matrix}$$

wherein [X] denotes the concentration of a particular molecular species X. A is an autoinducer AI, R is the receptor LasR, RA is the LasR-AI complex, and C is the dimerized complex, while c_{A} and c_{R} account for the basal level transcription of A and R, respectively. The values and references of the parameters are adapted from a general LuxIR system and shown in Table I.

In general, there are several components of the QS system representing potential targets for QSI: (1) LasR activation; (2) AI formation and activity; and (3) LasR/LasI expression.

TABLE I

| Parameter | Value |
|---|---|
| c_{A}, c_{R}, c_{A} | 1e−4 |
| k_{A}, k_{R} | 2e−3 |
| K_{A}, K_{R} K_{QSI3} | 1e−6 |
| k₀, k₃, k₉, k₁₀, k₁₃ | 1e−2 |
| k₁, k₂, k₄, k₅, k₇, k₈ | 1e−1 |

(1) LasR activation: The most promising mechanism for inhibiting LasR activation is achieved through the use of AI analogues that act as antagonists for the real AI (i.e., 30-C12-HSL for the LasIR system). These molecules are likely to be similar in structure to the natural AI produced by P. aeruginosa and compete for LasR-receptors binding. Accordingly, Equation (2) needs to be modified to:

$$\frac{d [ R ]}{d t} = {c}_{R} + \frac{{k}_{R} [ C ]}{{K}_{R} + [ C ]} - {k}_{3} [ R ] - {k}_{1} [ R ] [ A ] + {k}_{2} [ RA ] - {k}_{7} [ R ] [ QSI 1 ] + {k}_{8} [ RQSI 1 ] \qquad ( 5 )$$

wherein [QSI1] stands for category 1 QSI, which inhibits the LasR activation, and [RQSI1] is the binding product of LasR and QSI1. Also, two more equations need to be added to describe the dynamics of [QSI1]:

$$\begin{matrix}\frac{d [ RQSI 1 ]}{d t} = {k}_{7} [ R ] [ QSI 1 ] + {k}_{8} [ RQSI 1 ] & ( 6 ) \\ \frac{d [ QSI 1 ]}{d t} = - {k}_{9} [ QSI 1 ] - {k}_{7} [ R ] [ QSI 1 ] + {k}_{8} [ RQSI 1 ] & ( 7 )\end{matrix}$$

wherein k₉ is the degradation rate of QSI1. It is assumed that the AI analogues have the same affinity as the native AI to the LasR receptor; therefore, the binding reaction rates satisfy k₇=k₁.

(2) AI formation and activity: AI molecules can diffuse in and out of the bacterial cell freely. Therefore, once they appear in the extracellular environment, they are potential targets for destruction or inactivation.

The AI-degrading enzyme, AI-lactonase (AiiA), was first identified in Bacillus species; it has been reported to deactivate the bacterial virulence through hydrolysis of the lactone ring of AI. Accordingly, Equation (1) needs to be modified to describe the AI-degradation by AiiA; also a new equation needs to be added to describe the AiiA degradation:

$$\begin{matrix}\frac{d [ A ]}{d t} = {c}_{A} + \frac{{k}_{A} [ C ]}{{K}_{A} + [ C ]} - {k}_{0} [ A ] - {k}_{1} [ R ] [ A ] + {k}_{2} [ RA ] - \frac{A [ QSI 2 ] {k}_{h}}{1 + g [ QSI 2 ]} & ( 8 ) \\ \frac{d [ QSI 2 ]}{d t} = - {k}_{10} [ QSI 2 ] & ( 9 )\end{matrix}$$

wherein [QSI2] stands for the concentration of category 2 QSI which inhibits the AI formation and activity. In these equations, kₕ=0.3 represents the hydrolysis reaction rate, g=2 is the coefficient of Michaelis-Menten kinetics, and k₁₀ is the AiiA degradation rate.

(3) LasR/LasI expressions: An alternative approach to the inhibition of QS involves antisense oligonucleotides that specifically bind to LasR/LasI transcripts and inhibit the genes' expression. Several factors, including GacA, Vfr, and RelA, have been demonstrated to positively regulate the expression of LasR. Deletion of Vfr virtually eliminates the expression of LasR and reduces the production of virulence factors. Therefore, here, QSI3 was considered for the inhibition of LasR expression. Accordingly, Equation (8) needs to be modified to account for LasR inhibition; also, a new equation for the QSI3 dynamics is added:

$$\begin{matrix}\frac{d [ R ]}{d t} = ( {c}_{R} + \frac{{k}_{R} [ C ]}{{K}_{R} + [ C ]} ) \frac{{K}_{QSI 3}}{{K}_{QSI 3} + [ QSI 3 ]} - {k}_{3} [ R ] - {k}_{1} [ R ] [ A ] ++ {k}_{2} [ RA ] - {k}_{7} [ R ] [ QSI 1 ] + {k}_{8} [ RQSI 1 ] & ( 10 ) \\ \frac{d [ QSI 3 ]}{d t} = - {k}_{11} [ QSI 3 ] & ( 11 )\end{matrix}$$

wherein [QSI3] stands for the concentration of category 3 QSI, which inhibits LasR expression, and k₁₁ is its degradation rate. Note that it is also possible to inhibit LasI expression, but only LasR inhibition is considered in this example.

The original pathogen population is inhibited from getting involved in QS by QSIs, while the QSI resistant mutants are unaffected and continue to utilize QS effectively even in the presence of QSIs. If the continuance of QS gives the mutant a higher fitness and growth advantage compared to the original population in a given environment, then the resistant mutant becomes dominant according to natural selection.

It has been long argued that quorum quenching has little impact on bacterial viability and therefore that it is unlikely to put a harsh selective pressure on pathogenic microbes or for bacteria to develop resistance to QSIs. Part of the reason that resistance to QSI was not observed before is that all QSIs were routinely tested in a rich medium where nutrition is not a constraint. The idea is that the QS genes are involved not only in the production/detection of AIs, but also in other QS signal transduction pathways. If a gene variation confers an advantage for bacteria fitness under the QSI treatment, then the natural selection would favor the spread of QSI resistance.

Others have developed a novel screening to test whether cells could develop resistance to the QSI C-30 by using adenosine as the sole carbon source; this is because bacteria growth on adenosine requires an active LasIR QS system to upregulate the expression of the nucleoside hydrolase (nuh) gene. Hence, if QSI C-30 inhibits the LasIR system, the pathogens grow more slowly on adenosine, and if pathogens develop resistance to C-30, they grow more rapidly on adenosine. Considering the fact that adenosine is produced from ATP at high levels in the human host during injury, ischemia, and inflammation, this resistance can significantly reduce the efficacy of the QSIs for clinical use.

(1) Selective Pressure: In general, the selective pressure caused by QSIs can be classified into two categories, one related to bacteria “social” behavior and the other due to individual regulation. As discussed above, the QS genes are involved not only in the production and detection of AIs (e.g., social behavior), but also in other QS signal transduction pathways (e.g., individual regulation).

For bacteria social behavior, QS enables a bacteria population to generate a coordinated response that is advantageous to its survival by improving the access to complex nutrients or environments, collective defense against other microorganisms or host defense mechanisms (see FIG. 5). Therefore, QSI resistant mutants which can continue to use the QS in the presence of QSIs have a better survival chance (i.e., growth advantage) compared to species that are vulnerable to QSIs.

The other mechanism is related to individual regulation because the QS system also regulates the expression of some proteins that are essential to the survival of bacteria in some environments. As shown in the C-30 resistance case, bacteria growth on adenosine requires an active LasIR QS system (see FIG. 5), therefore, the QSI resistant mutants have a clear growth advantage compared to the wild-type population.

After breaking down the sources of selective pressure, the selective pressure due to QSI of type i (i=1, 2, 3) can be defined as follows:

P_{QSIi}=ΣSⱼ+Σₖ (12)

wherein Sⱼ, Sₖ stand for selective pressures coming from bacteria social behavior and individual regulations, respectively. In practice, this P_{QSI}_{ᵢ} needs to be measured on a case-by-case basis depending on the bacteria strains, target environment, and the properties of the chosen QSIi. For the purposes of this example, P_{QSI}_{ᵢ} can be normalized to 1.

To determine the value of selective pressure, experimentally, we can measure the growth rate of QSI-sensitive (wild-type) and QSI-resistant (mutant) strain, and get P_{QSI}_{ᵢ} directly using Equation 13.

(2) Growth Advantage of Mutants: In practice, since the pathogens are more likely to encounter conditions where they starve for nutrients, it was assumed that the total number of cells saturates at Nₜₒₜ; Nₜₒₜ equals the sum of the wild-type strain Nₒ and the mutant strain, namely, Nₘ, i.e., Nₜₒₜ=Nₒ+Nₘ. Considering the growth advantage that the mutants have compared to the QSI-sensitive strain because of the continuance of QS and the exponential growth pattern of bacteria due to cell division, the population density dynamics were modeled using the following ODEs:

$$\frac{d Nm}{d t} = C \cdot Π ( {P}_{QSIi} [ QSIi ] ) {N}_{m} \qquad ( 13 )$$

$$\frac{d Na}{d t} = - \frac{d Nm}{d t} \qquad ( 14 )$$

wherein C is a scaling constant for cell growth rate in a given environment. For a QSI i, the product of its concentration [QSIi] and the selective pressure P_{QSIx} it can induce on the pathogens determines the growth rate for pathogen mutants. π(P_{QSIx}[QSIx]) accounts for the fact that multiple gene mutations need to happen simultaneously (when treated using multiple QSIs) for bacteria to regain QS ability and therefore acquire growth advantage compared to the wild-type population. Also, it was assumed that the total number of pathogen cells is constant in a nutrition limited environment; therefore, Equation (14) indicates that an increase of the mutant population results in a decrease of the QSI-sensitive strain population.

In this example, bacteria were modeled as non-overlapping spheres. The AI and QSIs diffuse freely in the environment, so the classical diffusion equation is used to model the chemical diffusion:

$$\frac{\partial c}{\partial t} = D {∇}^{2} c \qquad ( 15 )$$

wherein D=890 μm² /s is the diffusion coefficient used for all chemical settings and c is the concentration of a chemical. Also, AIs and some small QSIs can diffuse in and out of cells freely:

$$\begin{matrix}\frac{d {A}_{c}}{d t} = - {D}_{tran} ( {A}_{c} - {A}_{t} ) & ( 16 ) \\ \frac{d {A}_{i}}{d t} = - {D}_{tran} ( {A}_{e} - {A}_{i} ) & ( 17 )\end{matrix}$$

wherein Aₑ and Aᵢ represent the extracellular and intracellular concentration of AI, respectively. Dₜᵣₐₙₛ=0.1 is the transmembrane diffusion coefficient; note that the same equation is applied to small QSIs like AI analogues but not big ones like AiiA enzyme, which acts in the extracellular space.

As can be seen in FIG. 5, the LasR-AI complex controls the virulence expression; therefore, the virulence was calculated as the sum of LasR-AI complex concentration across the heterogeneous bacteria populations:

[v]=Nₒ[C]ₒ+Nₘ[C]ₘ (18)

wherein [v] is the virulence concentration and [C]ₒ and [C]ₘ are the average intracellular dimerized LasR-AI complex concentrations in the wild-type bacteria strain and the mutant resistant strain, respectively.

As an intermediate step toward the demonstration of the use of aspects of the present invention to model the interactions of multiple QSIs on the QR network, consideration was given to the effect of individual QSIs. This example utilized a simulated environment of size (1000 μm, 1000 μm, 100 μm) in which non-overlapping bacteria initial locations are randomly generated. To evaluate the efficacy of individual QSIs, the QSI concentration was set to be 0.5 mM, uniformly distributed in the environment, for all cases. The scaling constant relating the selective pressure to the growth pattern according to Equation (12) and Equation (13) was set to C=1. This scaling factor determines how fast bacteria can grow, which is further determined by bacteria species and the amount of available nutrients in the environment. For simplicity, selective pressure of individual inhibitors will be discussed further herein and P_{QSI}=0.1 for all inhibitors.

In this example, it was assumed that bacteria swim slowly at a velocity of 4 μm/s, doing a run-and-tumble motion in the environment. The boundaries of the environment are semi-permeable such that the chemicals do not accumulate infinitely in the environment. An open-source bacteria network simulator was used to perform all simulations.

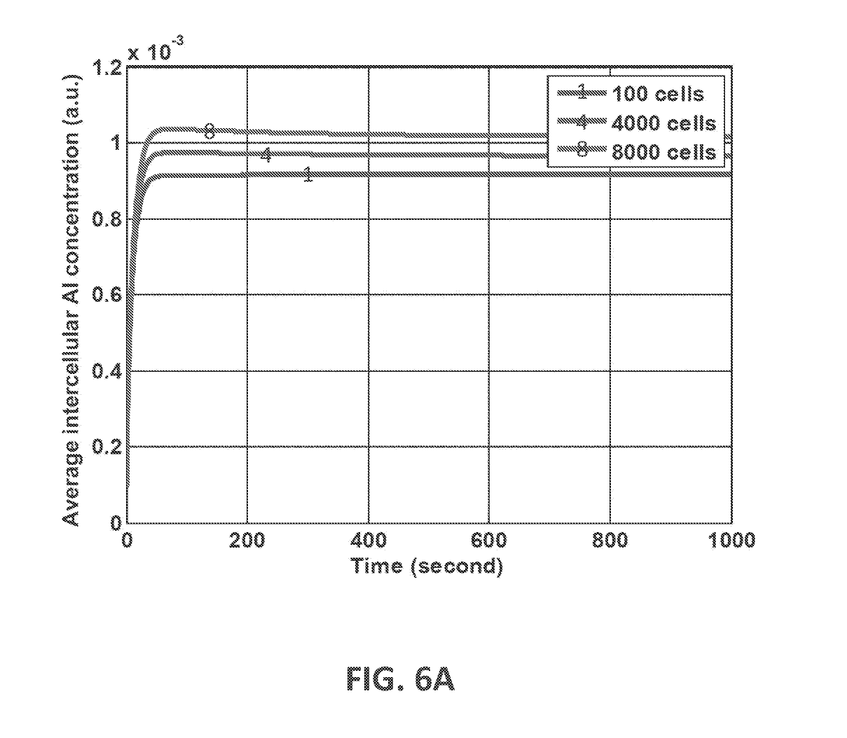

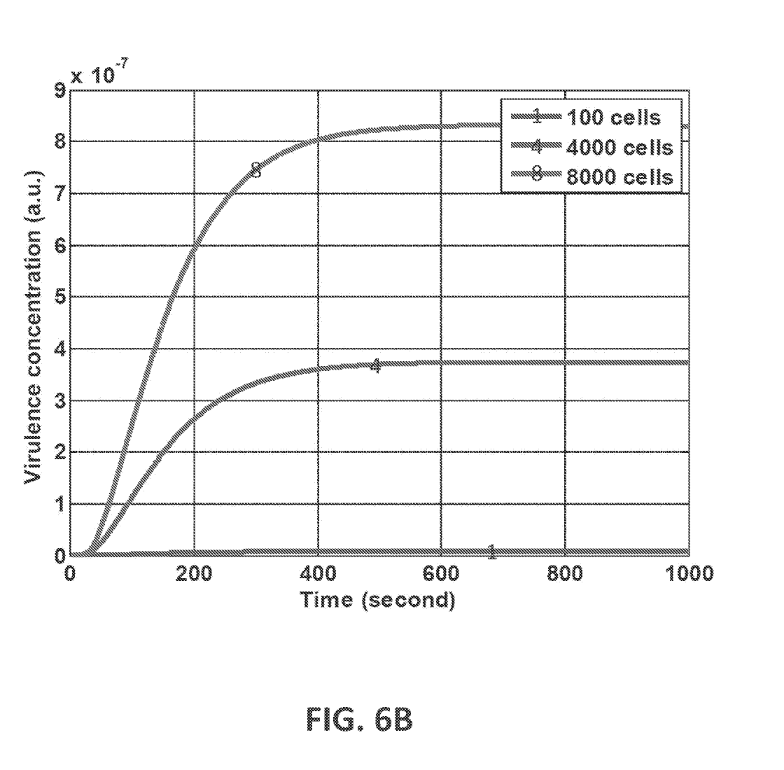

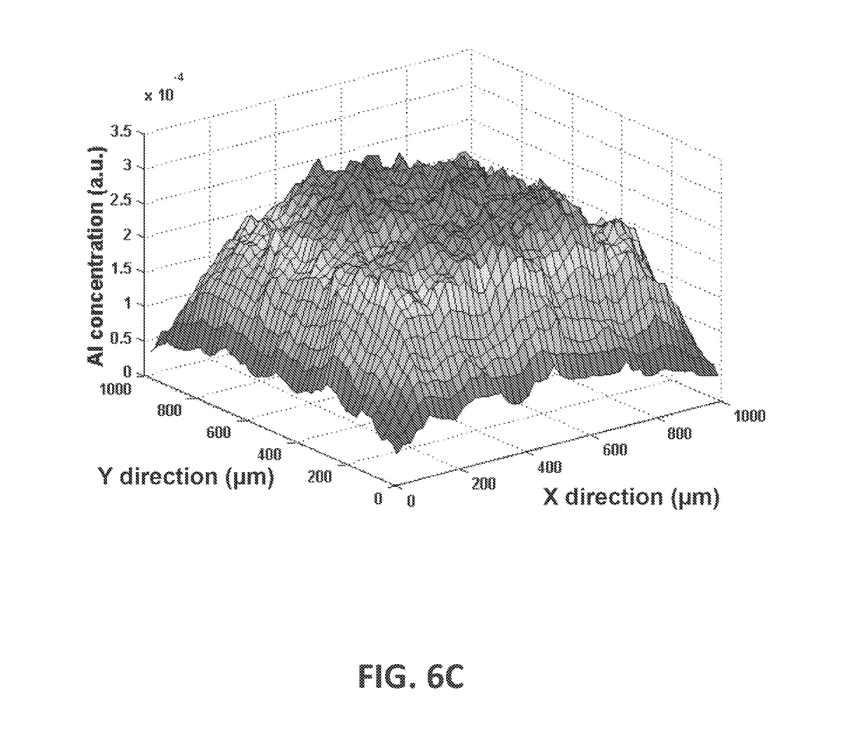

To establish a basis of comparison through which the effects of QSIs on the QS system can be seen, a control group was set up without any treatment. As can be seen in FIG. 6A, the pathogen population starts accumulating AI at the beginning and the concentration saturates at around t=60 s. The high AI concentration activates the production of more LasR and LasI through the two feedback loops, shown in FIG. 5, and therefore generates more virulence (FIG. 6B). However, in the 100 cells case, the AI concentration does not reach the activation threshold and therefore it does not cause any infection. It is clear that quorum sensing is a population density dependent phenomenon; this phase-transition type of phenomenon after the AI reaches a certain threshold has been observed from wet-lab experiments, so the model captures this behavior very well.

Finally, the AI spatial distribution in the environment when the system reaches equilibrium was drawn (FIG. 6C); the AI spatial distribution is clearly non-uniform with spikes showing small clusters of bacteria that form due to the random bacteria movement. From FIG. 6, it can clearly be seen that QS is a population density dependent phenomenon; at higher densities, more cells can activate the QS system and generate a QS response in a shorter time.

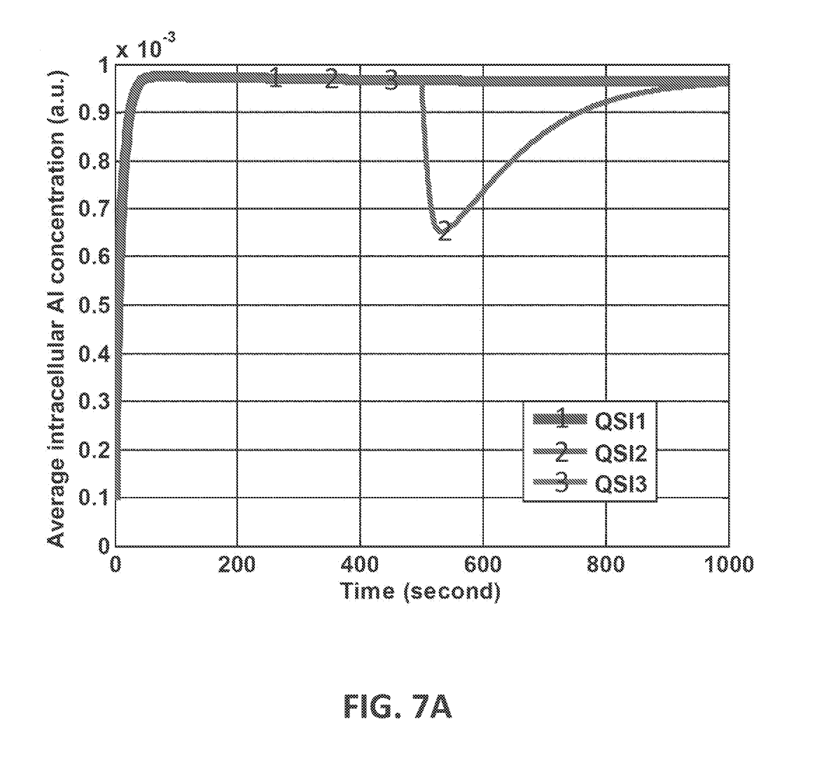

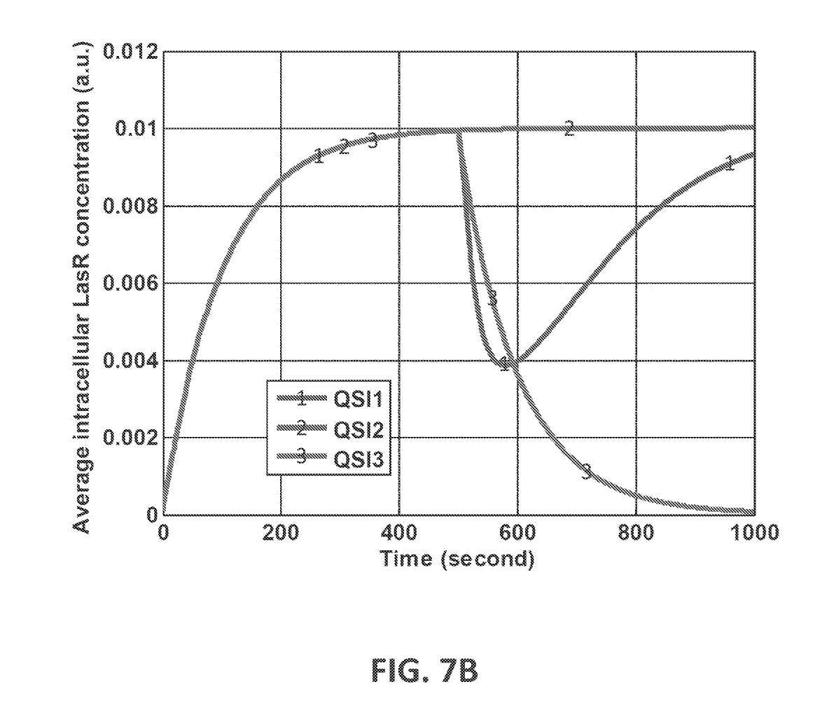

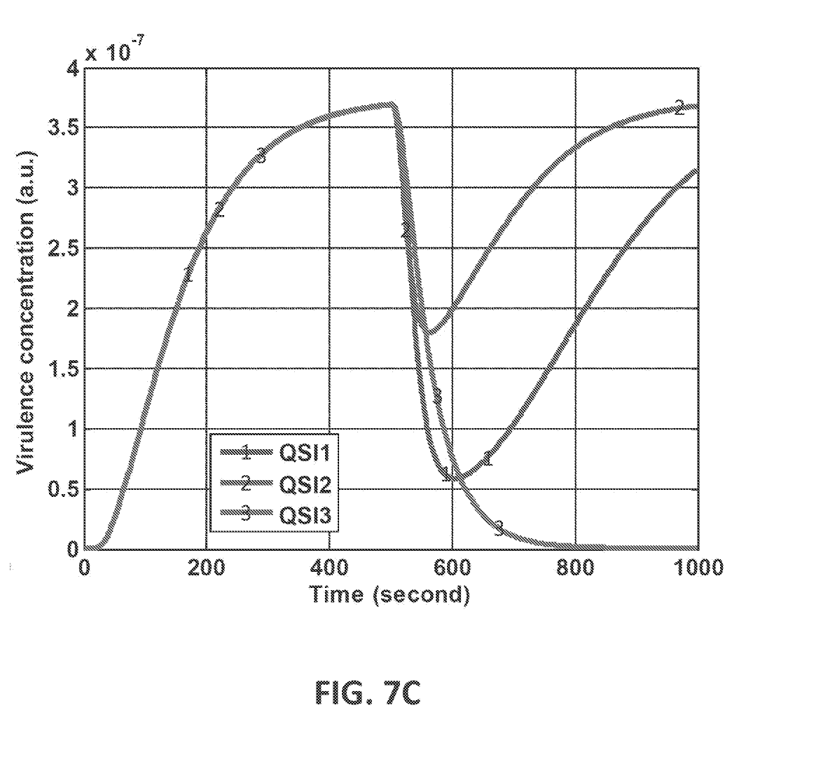

As discussed above, various QSIs target different components of the QS system. In order to see the efficacy of each individual QSI, the same environmental conditions were used as those used for the control group with the initial size of the wild-type bacteria population and mutant resistant population being Nₒ=4000 and Nₘ=1, respectively. Referring now to FIGS. 7A-7C, the efficacy of individual QSIs varies greatly as they rely on different inhibition mechanisms. FIG. 7A shows the average intracellular AI concentration and QSI1 and QSI3 do not reduce AI concentration directly, while QSI2 AI-degrading enzyme can effectively reduce AI concentration. FIG. 7B shows the average intracellular LasR concentration. FIG. 7B shows that QSI1 can significantly reduce the LasR concentration by forming LasR-QSI1 complex, while QSI3 targeting the LasR gene expression can almost eliminate all expressions of LasR. FIG. 7C illustrates a graphical representation of virulence concentration. Specifically, FIG. 7C reveals that the virulence is effectively reduced by all three categories of QSIs. Note that as the QSIs degrade and diffuse away, the effect of QSIs fade as time increases. QSI3 is the most efficacious as the virulence is almost cleared up. However, under the treatments with QSI1 and QSI2, the virulence concentration first decreases sharply, but then it recovers gradually. Note that in this setup, QSI3 only inhibits the LasR expression.

To explain these results, the inhibition mechanisms behind these QSIs need to be considered. QSI3 works the best because it really gets to the bottom of the QS system by inhibiting the LasR expression. As can be seen from the hill equation of the LasR gene expression, Equation (10), the dissociation constant K_{QSI3}=1e−6 mM is a very small number; this means that even a very small amount of QSI3 can largely inhibit the LasR transcription activity. QSI1 and QSI2, on the other hand, target the product of LasR and LasI transcription, namely, the LasR receptor and AI, which have significantly higher molar concentrations compared to the LasR gene in the cells; this requires a much larger amount of QSI for efficient inhibition. Therefore, since the same degradation rate and the same dosage were used for all three QSIs, QSI3 can remain effective for much longer than QSI1 and QSI2.

It is worth mentioning that QSI1 and QSI3 can also inhibit the generation of AI through the feedback loop controlled by LasR-AI complex; however, AI is largely stored in the environment, and the natural decay rate is much less than the enzyme hydrolysis reaction, as can be seen from FIGS. 7A-7C. On the other hand, QSIs do decay and diffuse away through the permeable boundaries. As a result of this, the efficacy of the QSIs decreases and the virulence concentration recovers, and thus a second (repeated) treatment is needed. However, that later treatment may lead to increased drug resistance, as discussed later.

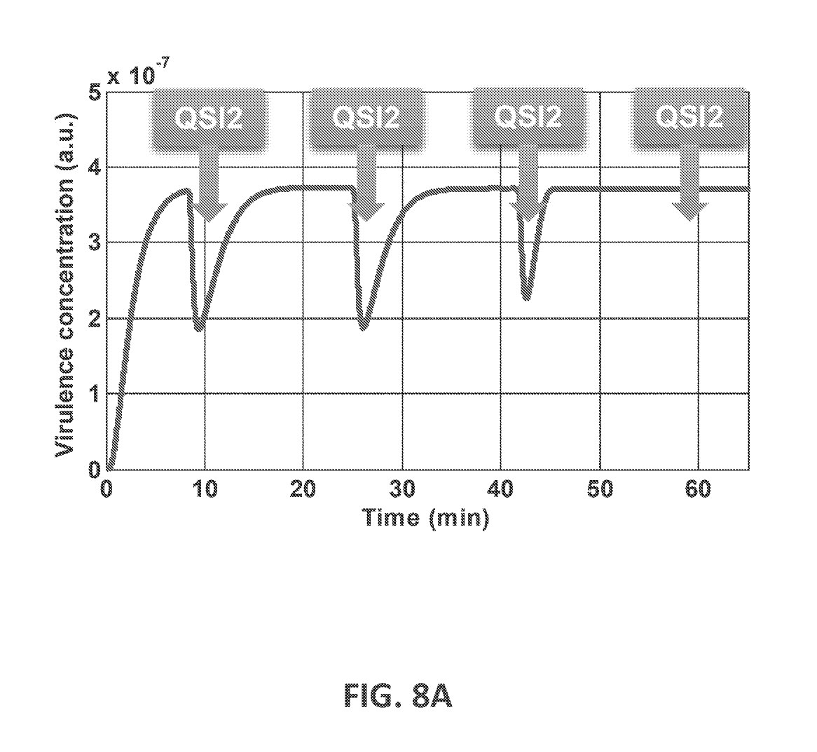

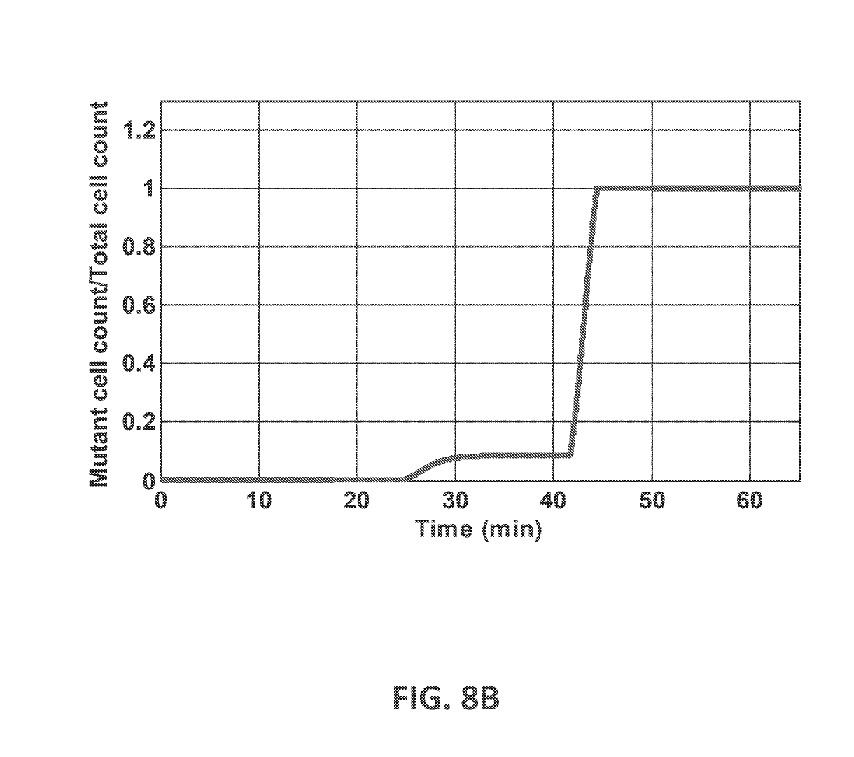

It is important to note that in this modeling, if a single QSI is used excessively, drug resistance development is inevitable and the QSI resistant mutant becomes a dominant species. To show this, QSI2 was applied to the pathogen population uniformly across the environment with a concentration of 0.5 mM every 16 minutes (time for QSIs to decay and diffuse away), starting from t=8 minutes. As can be seen from FIG. 8, the mutant strain population keeps increasing every time QSI2 is added to the environment. FIG. 8A shows a graphical representation of a single QSI virulence concentration; as shown, the continuance of QS increases the virulence concentration and makes QSI2 lose efficacy gradually. FIG. 8B shows a graphical representation of a single QSI mutant population ratio—when QSI2 is added the fourth time, there is no effect as the pathogen population consists of only mutant cells. As there are more and more QSI resistant mutant pathogens in the environment, the drug efficacy decreases significantly and virulence is hardly attenuated in the end. Therefore, to avoid the development of drug resistance, a multidrug approach is greatly needed such that the drug resistance genes do not develop easily and spread out widely.

The method of the present disclosure formulates the assessment of available treatment options as an optimization problem with the objective function aimed at maximizing the efficacy of the quorum quenching therapy. As can be seen in FIG. 5, the LasR-AI complex controls the virulence expression; therefore, the objective function should minimize the LasR-AI complex concentration. The binding reaction of LasR and AI forming LasR-AI complex can be expressed as:

LasR+AI [symbol] LasR−AI (19)

where the forward reaction rate is k₊=k₁[R][A]. In order to reduce the formation of the LasR-AI complex, QSI1 and QSI3 can target the reduction of LasR while QSI2 targets the reduction of AIs. Therefore, the combination of QSIs have a multiplicative effect on the reduction of the LasR-AI complex forming rate k₊.

As for the constraints of the optimization problem, various methods of the present disclosure are designed to limit the total selective pressure induced by the QSIs in a given environment; the higher the selective pressure these QSIs cause, the more likely bacteria will develop drug resistance. Since the mutant strain needs to be resistant to all QSI inhibition mechanisms at the same time, in order to continue QS, the selective pressure needs to be the product of contributions from all QSIs. Therefore, the optimization problem can be formulated as follows:

$$Objective \text{:} \\ max ( \frac{A [ QSI 2 ] {k}_{h}}{1 + g [ QSI 2 ]} \times \times ( {k}_{7} [ R ] [ QSI 1 ] - ( {c}_{R} + \frac{{k}_{R} [ C ]}{{K}_{R} + [ C ]} ) \frac{{K}_{QSI 3}}{{K}_{QSI 3} + [ QSI 3 ]} ) \\ Subject to \text{:} \\ {Π}_{i = 1}^{3} {P}_{QSIi} [ QSIi ] \leq P \\ [ QSIi ] >= 0 , i = 1 , … , 3 \qquad ( 20 )$$

where P is the total selective pressure threshold and P _{QSI}_{ᵢ} is the selective pressure induced by QSIᵢ. Note that all P _{QSI}_{ᵢ} values are normalized to (0,1].

To give some intuition about the objective function

$$\frac{A [ QSI 2 ] {k}_{h}}{( 1 + g [ QSI 2 ] )}$$

represents the reduction of AIs,

$${k}_{7} [ R ] [ QSI 1 ] and - ( {c}_{R} + \frac{{k}_{R} [ C ]}{{K}_{R} + [ C ]} ) \frac{{K}_{QSI 3}}{{K}_{QSI 3} + [ QSI 3 ]}$$

represents the increase of QSI1-LasR binding and the retardation of LasR transcription, respectively.

To make the optimization problem more clear, let C₁=[A]kₕ, C₂=k₇[R],

$${C}_{3} = {c}_{R} + \frac{{k}_{R} [ C ]}{{K}_{R} + [ C ]} , {C}_{4} = \frac{1}{{K}_{QSI 3}} , {x}_{i} = [ QSIi ] ;$$

then, the optimization problem can be rewritten as:

$$Objective \text{:} \\ max ( \frac{{C}_{1} {x}_{2}}{1 - {gx}_{2}} \times ( {C}_{2} {x}_{1} - \frac{{C}_{3}}{1 + {C}_{4} {x}_{3}} ) ) \\ Subject to \text{:} \\ {Π}_{i = 1}^{3} {P}_{xi} {x}_{i} \leq P \\ {x}_{i} >= 0 , i = 1 , 2 , 3 \qquad ( 21 )$$

The constraints can then be rewritten as g₁(x₁, x₂, x₃)=πᵢ₋₁³ Pₓᵢxᵢ−P≦0, g₂(x₁, x₂, x₃)=−x₁≦0, g₃(x₁, x2,x₃)=−x₂<0, g₄(x₁, x₂, x₃)=−x₃≦0; then the Lagrangian function of a maximization problem can be expressed as:

$$L ( {x}_{1} \cdot {x}_{2} \cdot {x}_{3} \cdot {μ}_{0} \cdot {μ}_{1} \cdot {μ}_{2} \cdot {μ}_{3} ) = \frac{{C}_{3} {x}_{3}}{1 + {gx}_{2}} ( {C}_{3} {x}_{1} - \frac{{C}_{3}}{1 + {C}_{4} {x}_{3}} ) ++ {μ}_{0} ( P - {\prod }_{i = 1}^{3} {P}_{xi} {x}_{i} ) + {\sum }_{i = 1}^{3} {μ}_{i} {x}_{i} \qquad ( 22 )$$

Thus the Karush-Kuhn-Tucker (KKT) conditions can be written as:

$$\begin{matrix}\frac{{C}_{1} {C}_{2} {x}_{2}}{1 + {gx}_{2}} - {μ}_{0} {P}_{x 1} + {μ}_{1} = 0 & ( 23 ) \\ ( \frac{{C}_{1}}{1 + {gx}_{2}} - \frac{{C}_{1} {x}_{2} g}{{( 1 + {gx}_{2} )}^{2}} ) ( {C}_{2} {x}_{3} -- \frac{{C}_{3}}{1 + {C}_{4} {x}_{3}} ) - {μ}_{0} {P}_{x2} + {μ}_{2} = 0 & ( 24 ) \\ \frac{{C}_{1} {x}_{2}}{1 - {gx}_{2}} \frac{{C}_{3} {C}_{4}}{{( 1 + {C}_{4} {x}_{3} )}^{2}} - {μ}_{0} {P}_{x3} + {μ}_{3} = 0 & ( 25 ) \\ {μ}_{0} ( P - {\prod }_{i = 1}^{3} {P}_{xi} {x}_{i} ) = 0 & ( 26 ) \\ {μ}_{i} {x}_{i} = 0 & ( 27 ) \\ {μ}_{0} \cdot {μ}_{i} \geq 0 , i = 1 , 2 , 3 & ( 28 )\end{matrix}$$

Case 1: Suppose μ₀=0. Then,

$${μ}_{3} = - \frac{{C}_{1} {x}_{2}}{1 + {gx}_{2}} \frac{{C}_{3} {C}_{4}}{{( 1 + {C}_{4} {x}_{3} )}^{2}} ,$$

because μ₃x₃=0, x₃ as QSI3 concentration cannot be 0, therefore,

$${μ}_{3} = - \frac{{C}_{1} {x}_{2}}{1 + {gx}_{2}} \frac{{C}_{3} {C}_{4}}{{( 1 + {C}_{4} {x}_{3} )}^{2}} = 0 ,$$

which requires x₂=0, which is obviously not acceptable.

Case 2: Suppose μ₀≠0. Then the KKT complementary slackness condition says P−πᵢ₋₁³ Pₓᵢxᵢ=0, and πᵢ₋₁³ Pₓᵢxᵢ=P>0, Since Pₓᵢ>0, for i=1, 2, 3, and therefore xᵢ>0 for i=1, 2, 3, then μᵢ=0 for i=1, 2, 3 to satisfy the KKT conditions. The final equations to solve the problem are:

$$\begin{matrix}\frac{{C}_{1} {C}_{2} {x}_{2}}{1 + {gx}_{2}} - {μ}_{0} {P}_{x 1} = 0 & ( 29 ) \\ ( \frac{{C}_{1}}{1 + {gx}_{2}} - \frac{{C}_{1} {x}_{2} g}{{( 1 + {gx}_{2} )}^{2}} ) ( {C}_{2} {x}_{1} - \frac{{C}_{3}}{1 + {C}_{4} {x}_{3}} ) - {μ}_{0} {P}_{x 2} = 0 & ( 30 ) \\ \frac{{C}_{1} {x}_{2}}{1 + {gx}_{3}} \frac{{C}_{3} {C}_{4}}{{( 1 + {C}_{4} {x}_{3} )}^{2}} - {μ}_{0} {P}_{x 3} = 0 & ( 31 ) \\ P - {\prod }_{i = 1}^{3} {P}_{xi} {x}_{i} = 0 & ( 32 )\end{matrix}$$

which are easily solvable. Since the ratio of each QSI concentration in the multidrug combination is desired, x₁:x₂:x₃ can provide the global optimum solution to maximize the efficacy of the quorum quenching therapy while constraining the total selective pressure induced by the QSIs in a given environment.

To further explain the present disclosure, one application to an exemplary scenario is described, namely QSIs targeting of P. aeruginosa with three categories of QSIs. Those skilled in the art will recognize that other pathogens could be assessed, and other combinations and additional types of QSIs could be assessed using the methods of the present disclosure.

In category one, QSI1 inhibitors target LasR activation using AI analogues. One of the most effective QSI1 available is the synthesized mBTL by O'Loughlin et al. in 2013. Experimental evidence shows that mBTL as AI analogues can effectively induce conformational changes in LasR receptors that impair their ability to interact with RNA polymerase, therefore lowering their transcriptional activation potential. This molecule has been tested in vivo and it does not affect P. aeruginosa growth, therefore it causes only a small selective pressure.

In category two, the best available QSI2 inhibitor is AiiA. This Al-degrading enzyme basically works in the environment without getting into the cells. QSIs extracellular work causes less pressure to develop resistance. Also, pathogen mutants which can pump QSIs like C-30 out of the cell should not affect the use of these extracellular QSIs.

In category three, QSIs target LasR/LasI transcripts and inhibit gene expressions. Several factors, including GacA, Vfr, and RelA, have been demonstrated to positively regulate the expression of LasR. Deletion of Vfr virtually eliminated all expression of LasR and reduced significantly the production of virulence factors (also see FIG. 7). However, a deletion of these global regulators, part of a two-component regulatory system, resulted in reduced production of other proteins, many of them being essential for bacteria growth and survival. Therefore, QSI3 can impose a great selective pressure on pathogens to develop drug resistance.

Based on this discussion, set Pₓ₁=0.1, Pₓ₂=0.1, Pₓ₃=0.9, and P=1e−3. Again, apply the QSIs at t=500 s after the pathogen population dynamics reaches equilibrium and the virulence concentration saturates. By measuring the chemical concentrations at t=500 s, it can be shown that

$${C}_{1} = [ A ] {k}_{h} = 3 e - 4 , {C}_{2} = {k}_{7} [ R ] = 1 e - 3 , \\ {C}_{3} = {c}_{R} + \frac{{k}_{R} [ C ]}{{K}_{R} + [ C ]} = 6.4 e - 4 , {C}_{4} = \frac{1}{{K}_{QSI 3}} = 1 e 6.$$

Taking these constants into Equations (29), (30), (31), and (32), the solution was found numerically using the Matlab nonlinear equation system solver, namely, x₁=0.0749, x₂=1.5299, x₃=0.9764, and μ₀=1.8799e −6. This solution is interesting because it basically means that not much QSI1 is needed. This makes sense because, although QSI1 as AI analogues can effectively reduce LasR concentration, QSI3 as LasR gene expression inhibitor can almost eliminate all LasR (see FIG. 7); therefore, it follows that there is not much need for QSI1. On the other hand, QSI2 is needed because it can hydrolyze AI molecules very quickly in the extracellular environment, while QSI3 and QSI1 do not inhibit AI directly but rather rely on AIs natural degradation.

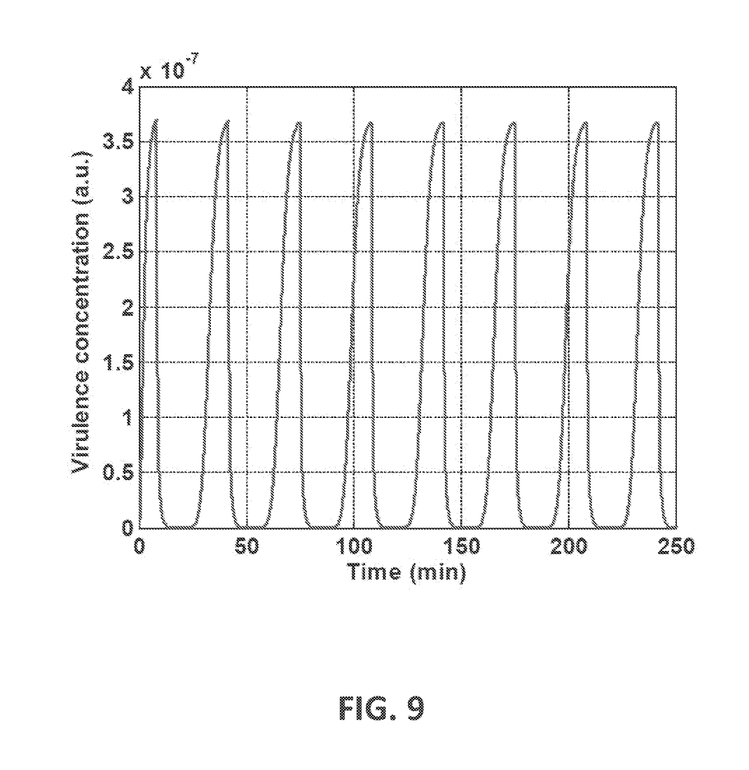

This solution was used to simulate the pathogen virulence dynamics. More specifically, similar to FIG. 8, the QSI combinations were added every 33 minutes (to allow drugs to degrade and diffuse away) to the pathogen population. The results in FIG. 9 show that the QSIs work effectively every time this multidrug treatment is applied, meaning that no drug resistance is developed during these treatments. This is because the constraint P=1e−3 is very tight which makes a (simultaneous) multiple gene mutation a rare event to happen. Therefore, the multidrug therapy can be applied continuously without too much concern for drug resistance development.

### EXAMPLE 2

### Fighting Pathogenesis Via Engineered Molecular Communication

Heavy and widespread use of antibiotics over the years in humans, farm animals, fish, and other lifeforms has driven pathogenic bacteria toward multidrug resistance. Recently, health officials have warned against the increasing resistance of bacteria to powerful Carbapenem antibiotics—one of the last drugs on the shelf. Moreover, investment in new antibiotic drug discovery by pharmaceutical companies is diminishing because of the low yield of the compound screening process, prescription habits (e.g., powerful antibiotics are often used as last resort), and the short clinical lifespans of antibiotics due to the rapid spread of resistance. Possible innovative strategies include anti-virulence therapy, which targets functions essential for infection spread rather than viability. One such emerging approach is to inhibit the bacteria intercellular molecular communication system, or QS, which controls biofilm formation and the expression of disease-causing virulence factors. Indeed, preliminary experiments have shown that quorum sensing inhibitors (QSIs) can quickly and significantly reduce pathogen virulence and make pathogens more susceptible to conventional antibiotics as well as the immune system.

However, to understand the microbial ecology and evolution and evaluate the efficacy of new anti-virulence therapeutics, one must understand the intercellular interactions through the molecular communication process. In previous studies, researchers have focused on molecular communication among a few cells, there has been no work addressing the population-level molecular communication network characterization with respect to bacterial evolution and pathogenesis.

However, evaluating the efficacy of these new anti-virulence therapeutics relies critically on understanding the effects of intercellular molecular communication on the ecology and evolution of heterogeneous microbial communities often found in clinical settings. The intracellular biochemical pathways giving rise to intercellular molecular signaling have been well studied from both molecular and biological perspectives. Yet, the endogenous mechanisms of such signaling systems are inextricably bound to exogenous processes, cues, and constraints, suggesting that, in isolation, intracellular models are unrealistic. Consequently, recent effort has been put forth to contextualize the intracellular signaling mechanisms within the scope of intercellular interactions. Nevertheless, this line of work has hitherto been limited to interactions among small groups of cells and has neither considered characterizations of molecular communication at a higher level of abstraction nor differentiated cell types capable of behavioral variances including cooperation, exploitation, and pathogenesis.

Molecular communication is an emerging area of science where various types of chemical molecules are used to convey specific information between agents at nanoscale. Researchers have been looking into different types of transport channels, such as diffusion, drift flow, molecular motors, and flagellated bacteria. However, different from previous studies, this disclosure focuses on biological stimuli and responses of bacterial cells in aggregate and how bacteria communication network dynamics correlate with pathogenesis.

To this end, a new computational model was developed for bacterial community dynamics capable of capturing highly emergent behaviors found at the population level. Furthermore, the molecular communication processes among individual cells are explicitly cast as a QS-based collaboration network. The paradigm of agent-based modeling was drawn from in this work, whereby each cell is outfitted with its own set of equations governing metabolic and communication processes. The model domain consists of a 3-dimensional micro-fluidic environment governed by the laws of diffusion and volume exclusion. The model incorporates molecular signaling, nutrient limited metabolism, exoproduct formation, and virulence processes that are crucial in the development and evolution of mixed biofilm communities.

Another novel aspect of this work was that a generic bacterial society often encountered in clinical studies was considered consisting of two types of pathogenic strains belonging to the same species: the wild-types (WT) and the signal-blind (SB) mutants. Within inchoate colonies, WT cells transmit and receive signaling molecules to coordinate collective behaviors, such as biofilm formation and production of virulence factors, in an attempt to increase group fitness. The SB cells, on the other hand, are unable to receive molecular signals and are thus barred from participating in these group behaviors. In the scenarios presented below in this example, the collective behavior is the production of EPS. A biofilm is any group of cells that stick to one another and are embedded within a self-produced matrix of extracellular polymeric substance (EPS). EPS is a polymeric conglomeration composed of extracellular DNA, proteins, and polysaccharides, which are key components for the structural formation of biofilms. EPS is considered a private exoproduct because, while it benefits producers by jettisoning them up into areas of higher nutrients, it cannot be exploited by non-producers.

Using the scenario described, the efficacy of two strategies for introducing QSIs into the environment were evaluated. The first approach is a non-targeted strategy in which the QSI is introduced uniformly across the entire domain. In contrast, the second approach is a targeted strategy in which engineered probiotic cells infiltrate regions of high cell density via chemotactic response and release QSI proportionally to the local concentration of signaling molecule. The targeted strategy proved highly effective while maximizing resource efficiency and minimizing the potential for side effects.

### EXAMPLE 2

### Model

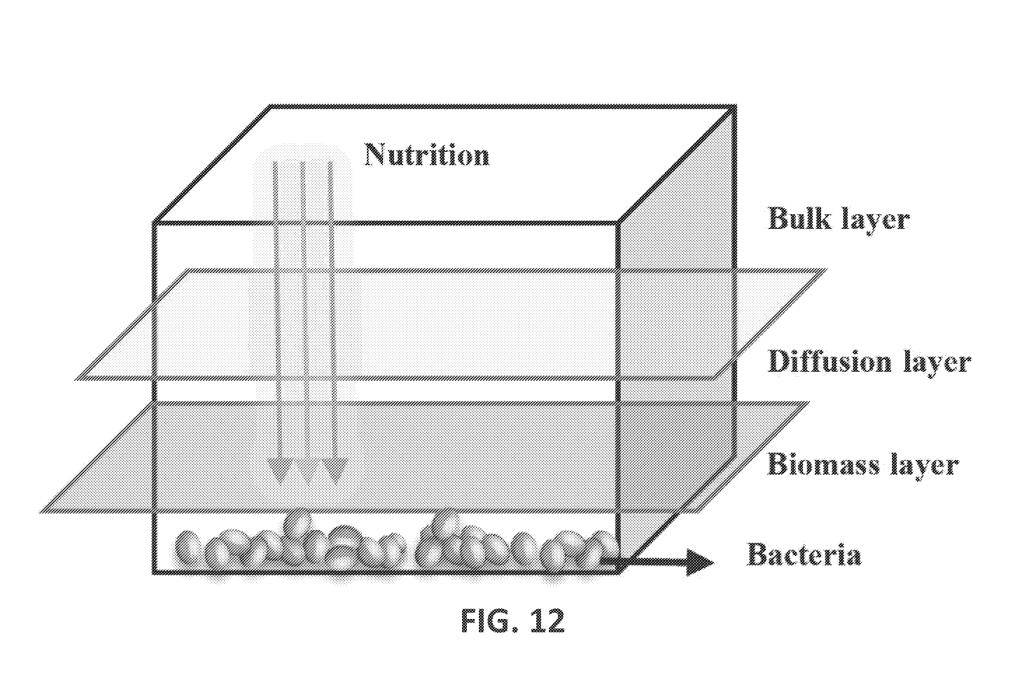

In the following subsections, the LuxI/R QS system used by most Gram-negative bacteria is described first, including how signal molecules are generated, how they bind to receptors, and how the binding product-receptor complex regulates the production of EPS and virulence. Then a single substrate growth model is described that was derived for use in a biofilm simulation environment with a constant nutrition concentration at the bulk layer (see FIG. 12). Lastly, a QS-based bacterial network is defined by identifying the signal spreaders, receivers, and responders in bacterial communities.

### EXAMPLE 2

### Intercellular Model

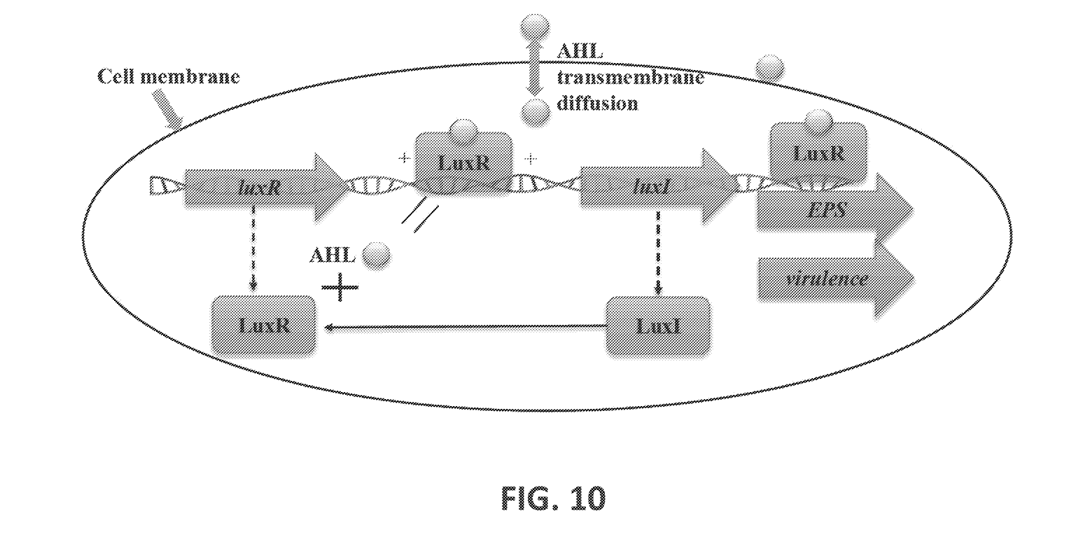

1) Quorum Sensing: The LuxI/R QS system is mediated by the AHL (i.e., 3O-C12-HSL for LasIR system) signal molecules produced by the synthase LuxI homologs, as shown in FIG. 10. With continued reference to FIG. 10, Gram-negative bacteria use largely LuxI/R homologous quorum-sensing networks, where the AHL molecules are detected and regulated via genetic circuits. Specifically, LuxI is an AHL synthase, LuxR is a receptor which can bind the AHL molecules, and the LuxR-AHL complex regulates the production of EPS and various virulence factors as shown in FIG. 10. The signaling molecules bind to the receptors and activate the transcription regulator (LuxR homologs). This complex leads to the transcription of a plurality of genes that are directly involved in regulating bacterial collective behavior.

The intracellular network of the LuxI/R QS system has two feedback loops. Indeed, as shown in FIG. 10, the LuxR-AHL complex up-regulates the expression of both luxR and luxI genes. Referring again to Equations 1-4 for the LuxIR QS system, where, as noted above, [X] denotes the concentration of a particular molecular species X, and, in this formulation, A stands for AHL, R is LuxR homologs, RA is the LuxR-AHL complex, C is the dimerized complex, and c_{A} and c_{R} account for the basal level transcription of A and R, respectively.

To give some intuition, the first term of Equation (1) describes the basal level transcription, the second term captures the positive feedback loop regulated by the dimerized complex C and the third and fourth terms describe the AHL concentration changes caused by the binding and unbinding reactions of AHL and LuxR receptor, respectively. Equation (3) and Equation (4) describe the binding reaction of AHL and LuxR receptor, as well as the dimerization process of the binding product [RA].

Therefore, to model the signal-blind mutants, set c_{R}=0 and k_{R}=0 to make sure there is no LuxR receptor ever produced, such that they cannot receive any molecular signals.

2) Quorum Sensing Inhibition: The most promising mechanism for inhibiting LuxR activation is achieved through the use of AHL analogues that act as antagonists for the native AHL. These molecules are likely to be similar in structure to the natural AHL and compete for LuxR-receptors binding (some can bind covalently). Accordingly, Equation (2) needs to be modified to:

$$\frac{d [ R ]}{d t} = {C}_{R} + \frac{{k}_{R} [ C ]}{{K}_{C} + [ C ]} - {k}_{3} [ R ] - {k}_{1} [ R ] [ A ] + {k}_{2} [ RA ] - {k}_{9} [ R ] [ {QSI}_{anlg} ] + {k}_{10} [ {RQSI}_{anlg} ] \qquad ( 33 )$$

where [QSI_{anlg}] stands for QSI which inhibits the LuxR activation, [RQSI_{anlg}] is the binding product of LuxR and [QSI_{anlg}]. Also, two new equations need to be added to describe the dynamics of [QSI_{anlg}]:

$$\begin{matrix}\frac{d [ {RQSI}_{anlg} ]}{d t} = {k}_{9} [ R ] [ {QSI}_{anlg} ] - {k}_{10} [ {RQSI}_{anlg} ] & ( 34 ) \\ \frac{d [ {QSI}_{anlg} ]}{d t} = {k}_{10} [ {RQSI}_{anlg} ] - {k}_{9} [ R ] [ {QSI}_{anlg} ] - {k}_{11} [ {QSI}_{anlg} ] & ( 35 )\end{matrix}$$

where k₁₁ is the degradation rate of QSI_{anlg}. The AHL analogues were assumed to have higher affinity as the native AHL to the LuxR receptor, and therefore the binding reaction rates satisfy k₉=5k₁.

3) Cell Growth: Monod introduced the concept of single nutrient controlled kinetics to describe microbial growth. The kinetic relates the specific growth rate (μ) of a bacterium cell mass (X) to the substrate concentration (S). The kinetic parameters, maximum specific growth rate (μₘₐₓ) and substrate affinity (Kₛ), were assumed to be constant and dependent on strain, medium, and growth conditions (e.g., temperature, pH).

When cells are metabolically active, but not growing or dividing, they may still take up substrate. This effect is not considered in Monod's original model. To address this, a maintenance rate (m) is generally used to describe the reduction, and Monod's model can be improved as follows:

$${μ}_{X} = {k}_{X} \cdot \frac{S}{S + {K}_{s}} - m \qquad ( 36 )$$

To balance the limiting substrate S, a growth yield parameter Y_{X/S} is introduced to model the consumption of substrate nutrition by cells:

$$\frac{d [ S ]}{d t} = - {U}_{X} \cdot {μ}_{X} \cdot X = - {U}_{X} \frac{d [ X ]}{d t} \qquad ( 37 )$$

Therefore, higher cell densities can lead to a decreased growth rate μ in a nutrition-limited environment.

Also, the cost of generating QS-related molecules needs to be accounted for; therefore, the consumption equation was modified to be:

$$\frac{d [ S ]}{d t} = - {U}_{X} \frac{d [ X ]}{d t} - {U}_{AHL} \frac{d [ A ]}{d t} - {U}_{LuxR} \frac{d [ R ]}{d t} \qquad ( 38 )$$

where utility parameters U_{AHL} and U_{LuxR} model the consumption of substrate nutrition due to the production of AHL and LuxR receptors, respectively.

4) EPS Production: The production of EPS was modeled as a function of the intracellular dimerized luxR-AHL complex C and incurred cost on the carbon substrate (S) in Equation 37:

$$\begin{matrix} \frac{d [ EPS ]}{d t} = {k}_{EPS} \frac{[ C ]}{[ C ] + {K}_{C}} & ( 39 ) \\ \frac{d [ S ]}{d t} = - {U}_{x} \frac{d [ X ]}{d t} - {U}_{AHL} \frac{d [ A ]}{d t} - {U}_{LuxR} \frac{d [ R ]}{d t} - {U}_{EPS} \frac{d [ EPS ]}{d t} & ( 40 )\end{matrix}$$

where Kₑₚₛ is the maximum EPS production rate and Uₑₚₛ is the utility of EPS production. Using this model, a maximum rate of EPS production was expected once cells reached a quorum through communication (i.e., the level of AHL in the extracellular environment passes a given threshold).

### EXAMPLE 2

### Intercellular Network Model

The QS-based intercellular network targeted significantly differs from traditional networks for several reasons: (1) the signal molecules do not have specific destinations encoded in the message (e.g., the address in an Internet Protocol packet); they simply diffuse in the environment. Therefore, the information cannot be precisely “routed” to the target recipients in the network; (2) The diffusion of molecules is spatially limited and is significantly slower than the kinetic dynamics of bacteria. In other words, each bacterium has a limited influence range in space; for efficient communication, bacteria need to stay close to each other; and (3) the bacterial network based on QS uses signal molecule concentrations to represent the information generated collectively by a large number of bacteria, where each bacterium contributes only by a little to the overall AHL concentration in the extracellular space. Based on these observations, a new QS-based intercellular network model is proposed that considers the intracellular QS system molecular information as well as the extracellular physical diffusion limit. More specifically, a directed link from bacterium A to bacterium B is established under three conditions: (1) Bacteria A and B must be within a diffusion-limited signal influence range T_{D}; (2) the autoinducer signal concentration (AHL) inside bacterium A is larger than inside bacterium B. Hence, there is a descending AHL gradient from A to B; and (3) the concentration of the signal receptor (e.g., LuxR) of bacterium B is above a threshold T_{R}. The first condition represents the fact that chemical diffusion is relatively slow and distance limited; therefore, the AHL produced and secreted by a bacterium can only have a direct impact within a range T_{D} (depending on the AHL production rate, the properties of the signal molecules and their diffusion medium). The second condition specifies the direction of the link, while the third condition ensures that bacterium B is able to receive QS signals.

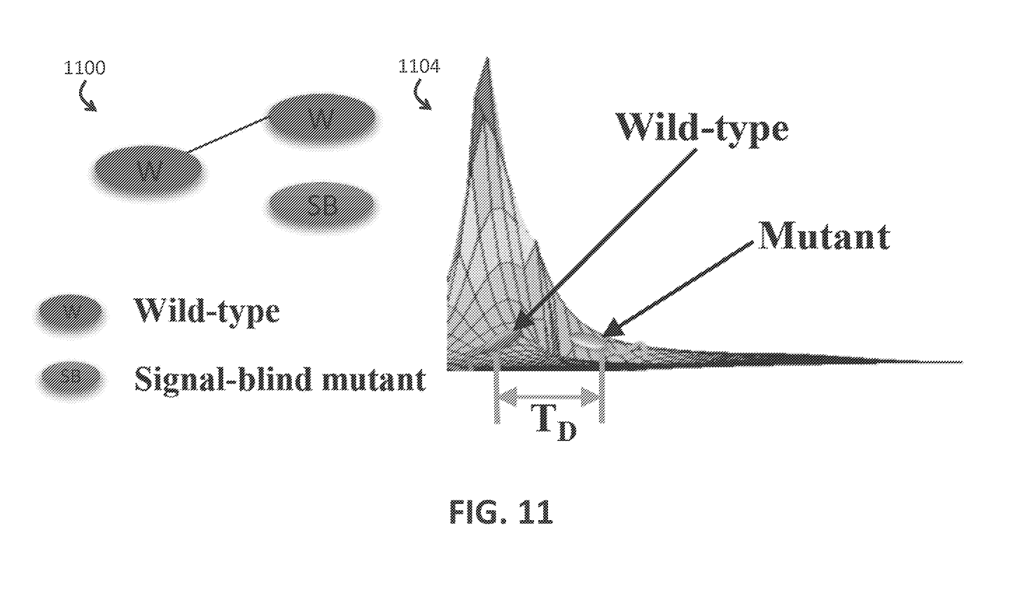

Referring now to FIG. 11, as shown in portion 1100, a wild-type bacteria (“W”) can connect to peers but not with signal-blind mutants (“SB”). With continued reference to FIG. 11, as shown at portion 1104, a chemical signal concentration profile generated by a wild-type cooperator, the distance of influence range T_{D} is determined by the signal production rate P_{A}; thus, a super spreader can establish links with recipient cells further away. To account for the different levels of AHL productivity of spreader bacteria, they were classified into four categories based on the intracellular AHL production rates P_{A}. The first category includes the spreaders when P_{A} is less than ¼ of the maximum production rate P_{A}^{max}=c_{A}+k_{A}; cells belonging to this category have an influence rage T_{D}=5 μm. Similarly, T_{D}=10 μm for the second category when

$$\frac{1}{4} {P}_{A}^{ max} < {P}_{A} \leq \frac{1}{2} {P}_{A}^{max} ; {T}_{D} = 20 µm$$

for the third category, when

$$\frac{1}{2} {P}_{A}^{ max} < {P}_{A} \leq \frac{3}{4} {P}_{A}^{ max} .$$

Finally T_{D}=40 μm for the super-spreader category with

$$\frac{3}{4} {P}_{A}^{ max} < {P}_{A} .$$

### EXAMPLE 2

### Probiotic Agent

Finally, a synthetic probiotic agent was introduced to the system. A probiotic is any bacterial cell which, through interactions with the environment or creation of exoproducts, promotes health benefits for its host. The engineered probiotic cell used in the targeted strategy for QSI delivery performs two primary functions. First, the cell uses chemotaxis, an intracellular chemical sensing mechanism which guides cells up chemical gradients, to detect and migrate toward areas of high WT density using AHL as the chemoattractant. A chemotactic model was used and calibrated using experimental data. Second, the synthetic cell regulates the amount of QSI delivered linearly with respect to the concentration of extracellular AHL. To prevent safety issues, they were not allowed to reproduce and thus their quantity was limited to the amount introduced at inoculation.

### EXAMPLE 2

### Results

A 3D environment of size (400 μm, 400 μm, 200 μm) was set up in which 50 non-overlapping bacteria (25 WT and 25 SB Mutants) were randomly attached to the surface at the bottom. To support the survival and growth of bacteria cells, a constant nutrition concentration of S=10 mM was assumed in the bulk layer such that the cells can get more nutrition as they grow upwards from the attachment surface towards the bulk layer, as shown in FIG. 12. FIG. 12 also illustrates that this environment is divided into three layers (i.e., bulk, boundary, and biomass). The chemical concentrations in the bulk layer do not change over time. The biomass layer is where the bacteria were located due to the secretion of EPS, the biomass layer having a diffusion coefficient value of about half that of the boundary layer. Bacterial cells attach to the surface and grow upwards while the nutrition diffuses from the bulk layer to the biomass layer.

A cell is considered to be a receiver when its intracellular LuxR concentration is above a threshold T_{R}=0.2 mM. A cell divides into two daughter cells when its radius grows above T_{div}=0.5 μm and dies when its value dips below T_{div}=0.5 μm. Dead cells are not cleared up from space but rather still exist as cell debris.

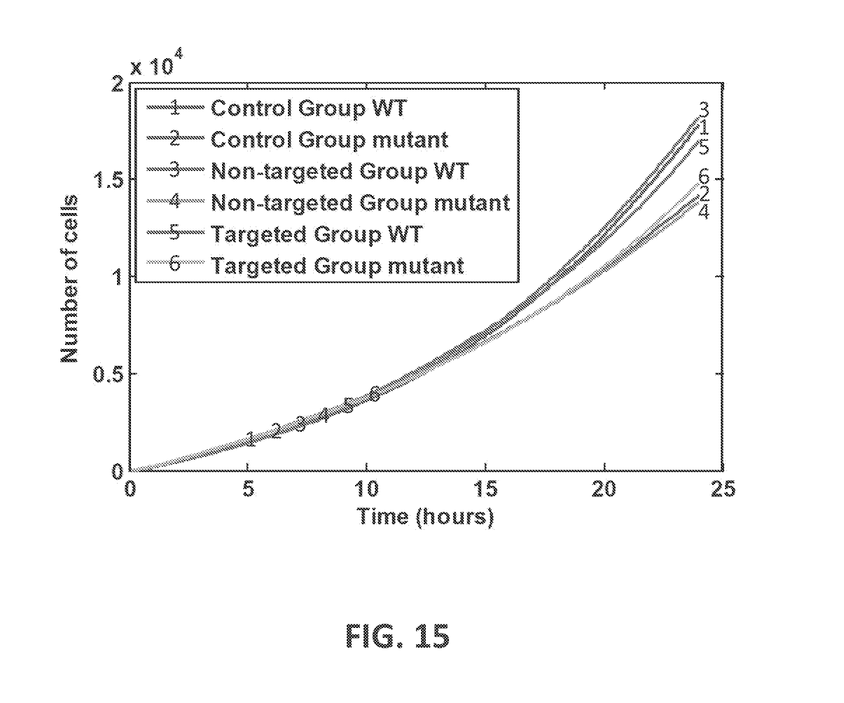

In this work, three scenarios were considered to evaluate the efficacy of each QSI strategy: (1) Control: half WT and half SB cells without any QSI; (2) Non-Targeted: half WT and half SB with a single instantaneous 1 mM dose of QSI into the diffusion layer at t=6 hrs; and (3) Targeted: half WT and half SB with a single inoculation of 2000 probiotic cells at t=6 hrs (see the total number of pathogen cells in FIG. 15). Hereafter, the results from these scenarios are described from various perspectives.

### EXAMPLE 2

### Results—Biofilm Evolution

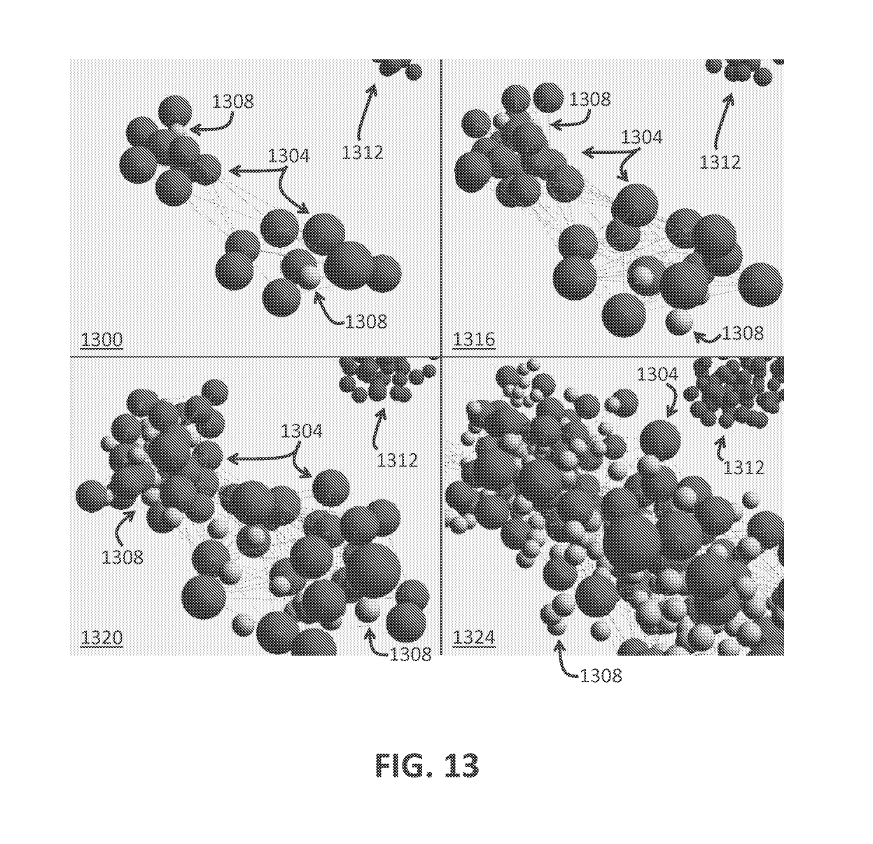

Referring now to FIG. 13, a magnified view of the emergence of clusters (communities) and their pivotal role in the biofilm formation process is shown. Referring to portion 1300, WT cells 1304 are initially randomly distributed, with only few cells aggregating at this stage due to low AHL production. Also shown in portion 1300 are EPS 1308 and signal blind mutants 1312. However, as the population grows, AHL production and thus concentration increases, leading to a surge in network density and clustering of WT cells 1304, which are best equipped for both transmission and reception, as illustrated at portion 1316 and portion 1320. Over time, cells aggregate to form large communities where communication is prevalent, which triggers an exponential increase in AHL production. It is at this threshold, as illustrated in portion 1324, that the full-fledged activation of the QS phenomenon can be observed, with tightly knit communities collaborating to produce EPS 1308 to the benefit of the colony and to the detriment of the host. It is thus clear that the sustained communication along the network links triggers the biofilm formation and the production of virulence factors.

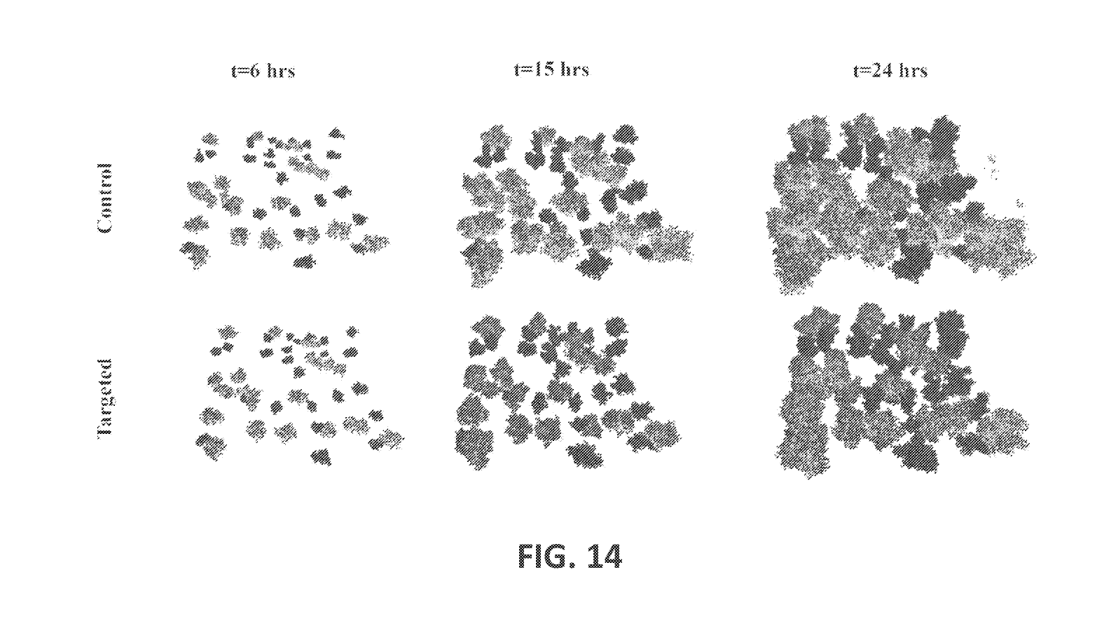

FIG. 14 shows the bacterial network and biofilm evolution with no intervention in the top half of the figure and under a targeted probiotic treatment in the bottom half of the figure. The probiotic is applied once at time t=6 hours in areas with highest cell density. The effect is visible at t=15 hours: there is no detrimental effect on individual cell livelihood; however, the probiotic treatment successfully eliminates the bacteria's ability to communicate (form links), thus significantly delaying the activation of QS and the production of virulence factors. At t=24 hours, due to continued pathogen population growth, the probiotic effect is overcome and communication re-established, which can be seen due to the emergence of EPS cells. However, because it has no effect on cell growth, and therefore does not induce drug resistance, additional probiotic intervention will be just as effective. This confirms the efficacy of probiotic treatments in eliminating the communication channels, which are vital in establishing a quorum, thus enabling virulence production. This kind of treatment can not only be used by itself for obtaining immediate results in chronic infections, but also in combination with certain antibiotics. In the latter case, the probiotics can be used to expose the colony that is usually well insulated by the protective biofilm, enabling significantly increased antibiotic effectiveness.

### EXAMPLE 2

### Results—Biofilm & Network Measures

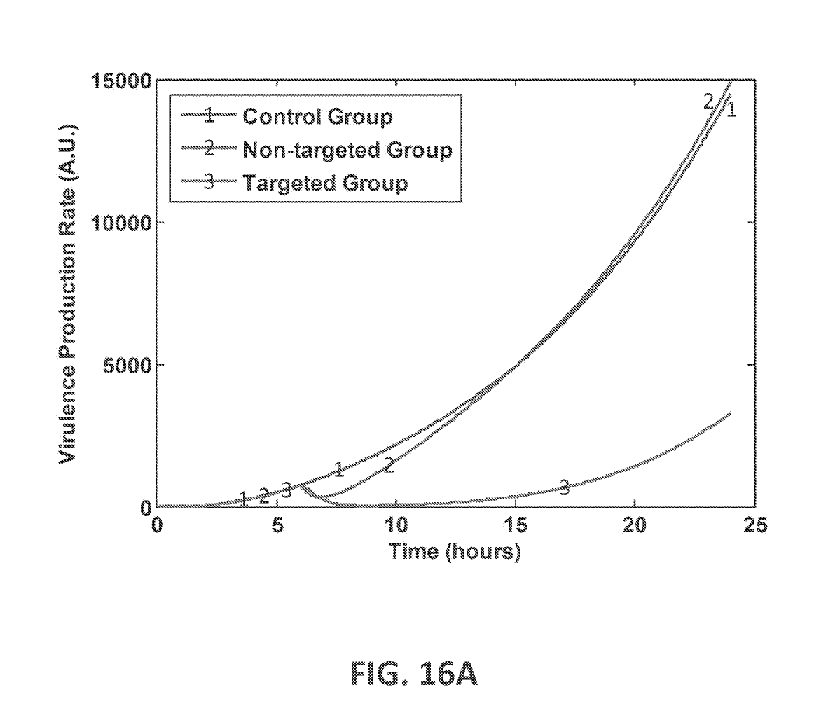

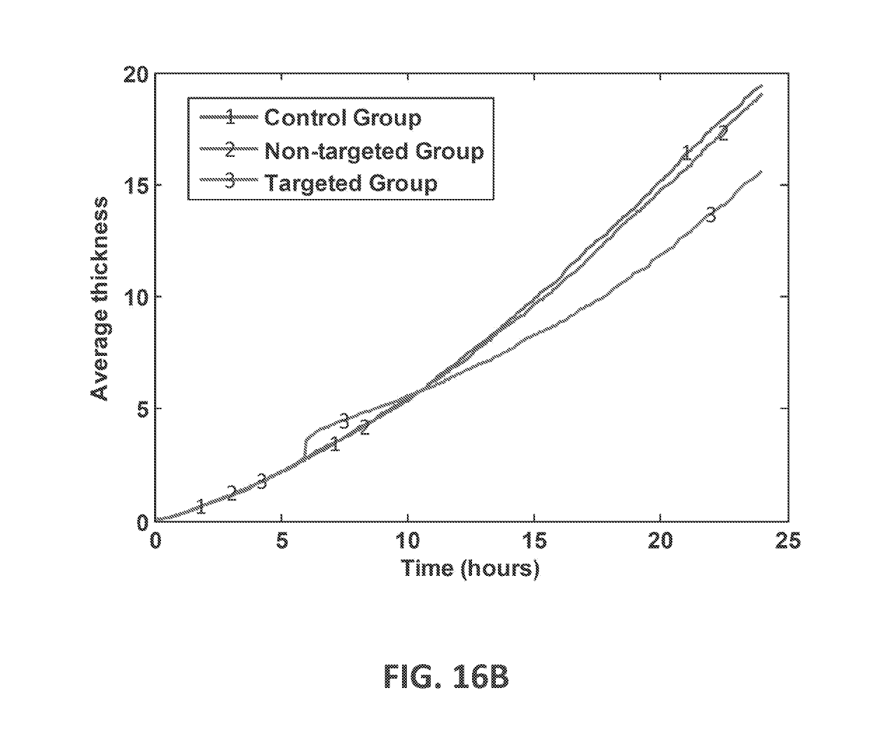

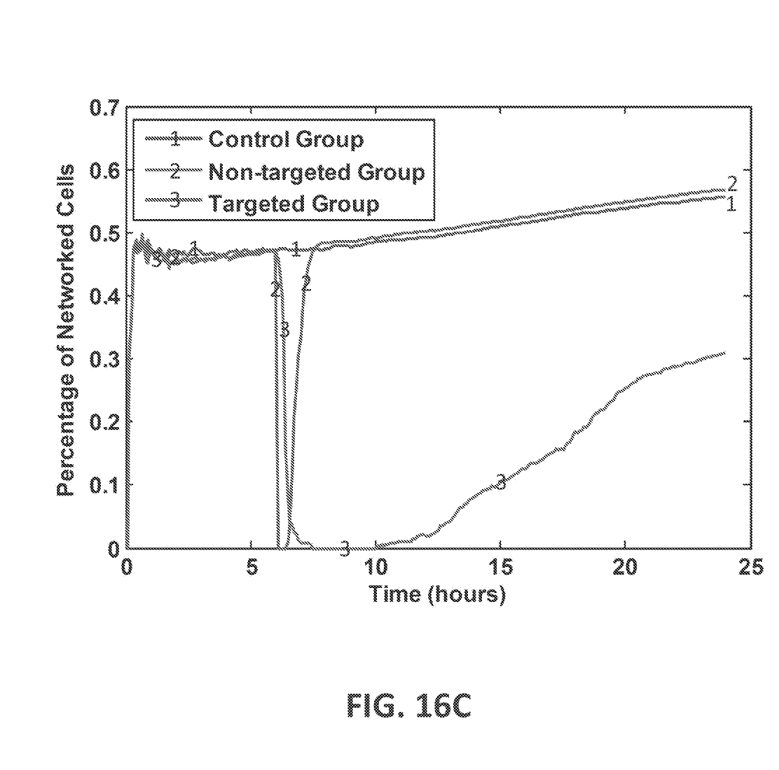

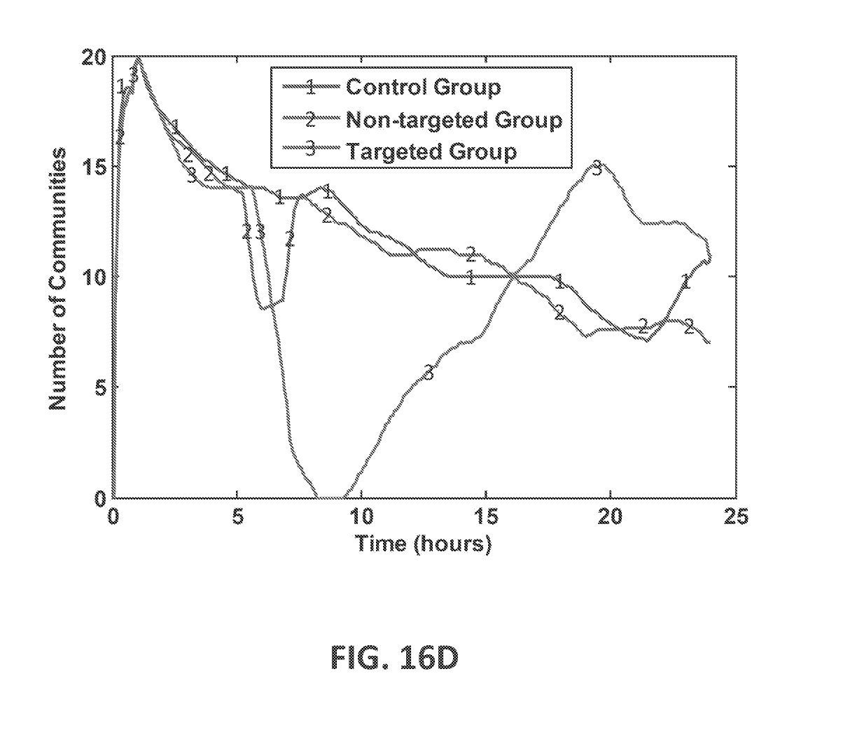

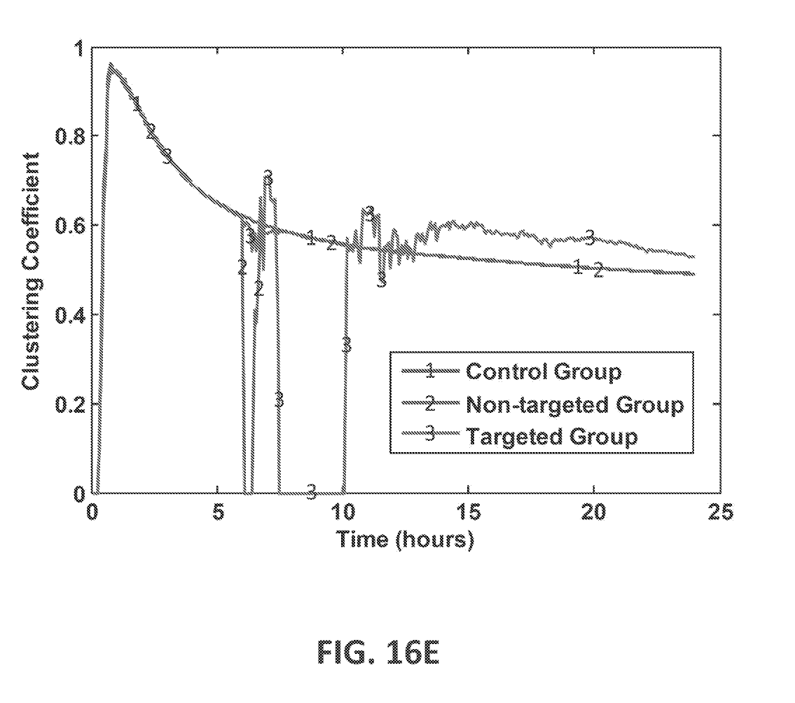

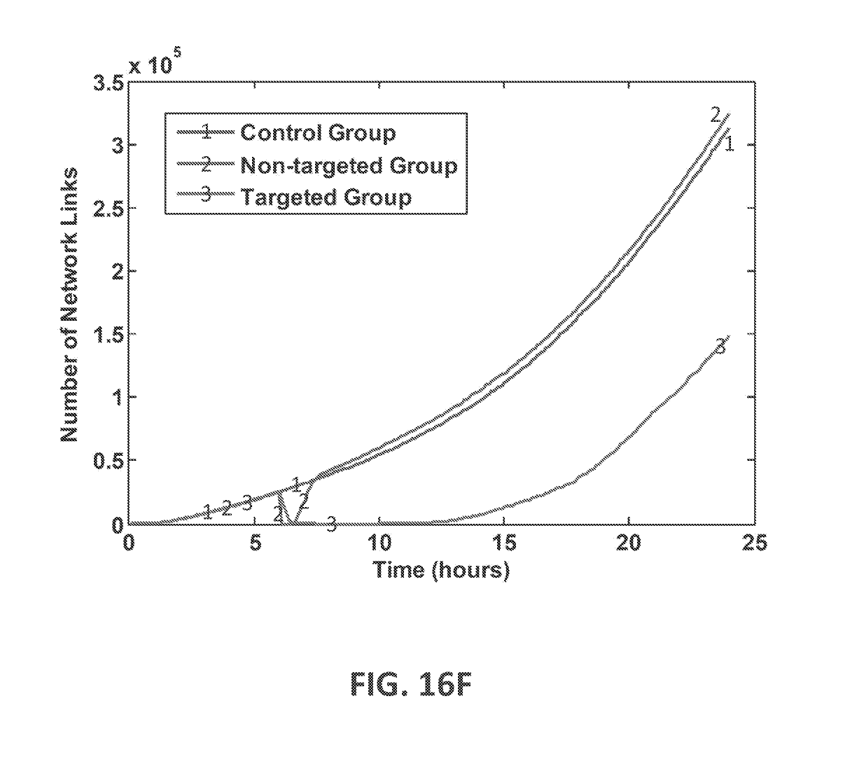

Virulence Production: Here it was assumed that virulence factors were under positive regulation by the LuxR-AHL complex. It was discovered that under the influence of QSI the virulence production rate is reduced. Referring to FIG. 16A, it was observed that virulence production was minimized under the targeted drug strategy. This is due to the fact that the delivery of QSI prohibits an increase in AHL concentration and hence up-regulation of virulence production. However, the targeted cells continue to grow and reproduce, while the probiotics are unable to reproduce. For this reason, the probiotics are eventually outnumbered by the target WT cells and unable to further produce enough QSI.

Biofilm Thickness: Similarly, as shown in FIG. 16B, the targeted strategy was shown to yield a lower (final) biofilm thickness. Interestingly, the thickness increases around the time of probiotic inoculation. This is due to the fact that the biofilm thickness measures the average height at which cells reside and, during inoculation, probiotic cells are planktonic and chemotaxing above the surface of the biofilm. As the probiotics swim closer to the areas of high cell density, the thickness decreases to the true value.

Communities & Clustering: In FIG. 16D, the time evolution of the community count manifest from the communication network can be observed. Interestingly, the number of communities can be seen to dramatically decrease to zero under the targeted strategy but only reduces slightly under the non-targeted strategy. This is explained by the fact that the probiotics release QSI exclusively in regions of high cell density and do not waste QSI in unoccupied areas. In contrast, the control scenario decreases in its number of communities because the network becomes more fully connected as time progresses. The time evolution of the clustering coefficient is shown in FIG. 16E and describes similar effects. It is worth noting that the there is a delay in the decrease of the clustering coefficient from the non-targeted to targeted strategy due to the fact that the probiotics are first required to migrate to areas of high cell density before QSI is delivered. The fluctuations seen before the decrease in clustering are a stochastic effect arising from the path the probiotic cells take to reach cluster centers.

Network Nodes & Edges: FIGS. 16C and 16F show the time evolution of the network nodes and edges, respectively. The results corroborate the strength of the targeted strategy in collapsing the molecular communication network among cells.

The two QSI delivery strategies can be summarized as non-targeted and targeted, respectively. In the non-targeted case, a one-time dose of QSI is injected uniformly into the bulk layer of the domain and freely diffuses. In addition to this strategy being ineffective in its reduction of virulence production among WT cells as demonstrated in FIG. 16A, it is also sub-optimal with respect to resource utilization. For example, consider a spatial distribution in which WT cells occupy only a limited area of the domain. In this case, a significant proportion of the released drug would diffuse to empty regions having no effect on the target cells. Furthermore, due to the indiscriminate QSI delivery of this approach, groups of beneficial bacteria could get caught in the crossfire and become inadvertently inhibited leading to undesired consequences.

Conversely, the targeted strategy using engineered probiotic cells provides a more robust solution. As can be seen in FIG. 16, this strategy achieves a significantly more effective result in deteriorating the communication network among target cells. In this case, QSI is exclusively delivered to regions of high WT cell density, thus avoiding the problems of resource inefficiency and friendly fire encountered by the non-targeted strategy.

### Exemplary Computing System

It is to be noted that any one or more of the aspects and embodiments described herein may be conveniently implemented using one or more machines programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing system) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing system) and any related information (e.g., data structures and data) that causes the machine to perform any one of the methodologies and/or embodiments described herein.

Examples of a computing system include, but are not limited to, an electronic book reading device, a computer workstation, a homogeneous or heterogeneous multiprocessor platform, any CPU/FPGA/GPU-based platform, a terminal computer, a server computer, a wearable computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing system may include and/or be included in a kiosk.

FIG. 17 shows a diagrammatic representation of one embodiment of a computing system in the exemplary form of a computer system 1700 within which a set of instructions for causing a control system to perform any one or more of the aspects and/or methodologies of the present disclosure, such as methods 100 and 300 of FIGS. 1 and 3, respectively, may be executed. It is also contemplated that multiple computing systems may be utilized to implement a specially configured set of instructions for causing one or more of the devices to perform any one or more of the aspects and/or methodologies of the present disclosure. Computer system 1700 includes one or more processors 1704 and a memory 1708 that communicate with each other, and with other components, via a bus 1712, although additional or alternative communication types could be used such as one or more point-to-point (P2P) communication schemes or network-on-chip schemes. Bus 1712 and/or one or more P2P and/or network-on-chip schemes may include any of several types of bus structures including, but not limited to, a memory bus, a memory controller, a peripheral bus, a local bus, and any combinations thereof, using any of a variety of bus architectures.

Memory 1708 may include various components (e.g., machine readable media) including, but not limited to, a random access memory component, a read only component, and any combinations thereof. In one example, a basic input/output system 1716 (BIOS), including basic routines that help to transfer information between elements within computer system 1700, such as during start-up, may be stored in memory 1708. Memory 1708 may also include (e.g., stored on one or more machine-readable media) instructions (e.g., software) 1720 embodying any one or more of the aspects and/or methodologies of the present disclosure. In another example, memory 1708 may further include any number of program modules including, but not limited to, an operating system, one or more application programs, other program modules, program data, and any combinations thereof.

Computer system 1700 may also include a storage device 1724. Examples of a storage device (e.g., storage device 1724) include, but are not limited to, a hard disk drive, a magnetic disk drive, an optical disc drive in combination with an optical medium, a solid-state memory device, and any combinations thereof. Storage device 1724 may be connected to bus 1712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1724 (or one or more components thereof) may be removably interfaced with computer system 1700 (e.g., via an external port connector (not shown)). Particularly, storage device 1724 and an associated machine-readable medium 1728 may provide nonvolatile and/or volatile storage of machine-readable instructions, data structures, program modules, and/or other data for computer system 1700. In one example, software 1720 may reside, completely or partially, within machine-readable medium 1728. In another example, software 1720 may reside, completely or partially, within processor 1704.

Computer system 1700 may also include an input device 1732. In one example, a user of computer system 1700 may enter commands and/or other information into computer system 1700 via input device 1732. Examples of an input device 1732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1732 may be interfaced to bus 1712 via any of a variety of interfaces (not shown) including, but not limited to, a serial interface, a parallel interface, a game port, a USB interface, a FIREWIRE interface, a direct interface to bus 1712, and any combinations thereof. Input device 1732 may include a touch screen interface that may be a part of or separate from display 1736, discussed further below. Input device 1732 may be utilized as a user selection device for selecting one or more graphical representations in a graphical interface as described above.

A user may also input commands and/or other information to computer system 1700 via storage device 1724 (e.g., a removable disk drive, a flash drive, etc.) and/or network interface device 1740. A network interface device, such as network interface device 1740, may be utilized for connecting computer system 1700 to one or more of a variety of networks, such as network 1744, and one or more remote devices 1748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing systems, and any combinations thereof. A network, such as network 1744, may employ a wired and/or a wireless mode of communication and may comprise one or more cloud computing services or schemes. In general, any network topology may be used. Information (e.g., data, software 1720, etc.) may be communicated to and/or from computer system 1700 via network interface device 1740.

Computer system 1700 may further include a video display adapter 1752 for communicating a displayable image to a display device, such as display device 1736. Examples of a display device include, but are not limited to, a liquid crystal display (LCD), a cathode ray tube (CRT), a plasma display, a light emitting diode (LED) display, and any combinations thereof. Display adapter 1752 and display device 1736 may be utilized in combination with processor 1704 to provide graphical representations of aspects of the present disclosure. In addition to a display device, computer system 1700 may include one or more other peripheral output devices including, but not limited to, an audio speaker, a printer, and any combinations thereof. Such peripheral output devices may be connected to bus 1712 via a peripheral interface 1756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve various aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of generating a therapy recommendation for inhibiting pathogenesis or growth of one or more cell colonies, wherein the therapy includes a plurality of differing therapeutic agents, the method performed by a computing system and comprising:
receiving an indication of one or more types of cells in the one or more cell colonies;
solving an optimization problem to generate at least a portion of a therapy recommendation specifying relative amounts of the plurality of differing therapeutic agents to administer in combination with one another, wherein the optimization problem includes:
accounting for a dynamic molecular-level model that models 1) a cell population representing the one or more cell colonies, 2) differing components of one or more resistance-forming mechanisms of the one or more types of cells, and 3) effects that the differing therapeutic agents have on the differing components; and
accounting for a selective-pressure model configured to assess probabilities of inducing selective pressure on the cell population; and
providing or applying the therapy recommendation to a user, wherein the therapy recommendation is based on the relative amounts of the plurality of differing therapeutic agents.

2. A method according to claim 1, wherein said accounting for the dynamic molecular-level model includes accounting for a model of a quorum sensing system for each of the one or more cell colonies.

3. A method according to claim 2, wherein said accounting for a model of a quorum sensing system for each of the one or more cell colonies includes accounting for a model of quorum sensing for a bacterial colony.

4. A method according to claim 3, wherein said accounting for the model of quorum sensing for the bacterial colony includes accounting for two types of bacterial strains belonging to the same species.

5. A method according to claim 4, wherein said accounting for the two types of bacterial strains belonging to the same species includes accounting for wild-types and signal-blind mutants.

6. A method according to claim 1, wherein said accounting for the dynamic molecular-level model includes deriving a single substrate growth model.

7. A method according to claim 6, wherein said deriving a single substrate growth model includes accounting for when the cells of the cell population are metabolically active but not growing or dividing.

8. A method according to claim 1, wherein said accounting for the dynamic molecular-level model includes accounting for production of an extracellular polymeric substance (EPS) produced by the one or more cell colonies.

9. A method according to claim 8, wherein said accounting for production of the EPS produced by the one or more cell colonies includes accounting for production of an EPS produced by one or more cancer cell colonies.

10. A method according to claim 1, wherein said accounting for the dynamic molecular-level model includes modeling communication between cells of at least one of the cell colonies of the one or more cell colonies.

11. A method according to claim 10, wherein said modeling communication (i.e., network) between cells of the at least one cell colony includes modeling signal molecules produced by cells within the at least one cell colony.

12. A method according to claim 11, wherein said modeling signal molecules produced by cells within the at least one cell colony includes accounting for properties of the signal molecules and for a extracellular physical diffusion limit.

13. A method according to claim 11, wherein said modeling signal molecules produced by cells within the at least one cell colony includes modeling signal molecules that do not have specific destinations encoded.

14. A method according to claim 1, wherein said accounting for the dynamic molecular-level model includes accounting for a diffusion-limited signal influence range.

15. A method according to claim 1, wherein said accounting for the dynamic molecular-level model includes accounting for a varied autoinducer signal influence range for particular cells within the one or more cell colonies.

16. A method according to claim 1, wherein said accounting for the dynamic molecular-level model includes accounting for a concentration of signal receptors for a cell within the one or more cell colonies.

17. A method according to claim 1, wherein said accounting for the dynamic molecular-level model includes modeling effects of a probiotic agent on the one or more cell colonies.

18. A method according to claim 1, wherein said accounting for a selective-pressure model includes accounting at least for selective pressures sourced from social behavior of the cell colony and individual regulation of a cell within the cell colony.

19. A method according to claim 18, wherein said accounting at least for selective pressures sourced from social behavior of the cell colony and individual regulation of a cell within the cell colony includes accounting for a growth advantage of a mutant cell within the cell colony.

20. A method according to claim 1, wherein said accounting for the dynamic molecular-level model includes accounting for virulence concentration.

21. A method according to claim 1, wherein said accounting for the dynamic molecular-level model includes accounting for the effect of individual quorum sensing inhibitors.

22. A machine-readable storage medium containing machine-executable instructions for performing a method of generating a therapy recommendation for inhibiting pathogenesis or growth of one or more cell colonies, wherein the therapy includes a plurality of differing therapeutic agents, the method performed by a computing system, said machine-executable instructions comprising:
a first set of machine-executable instructions for receiving an indication of one or more types of cells in the one or more cell colonies;
a second set of machine-executable instructions for solving an optimization problem to generate at least a portion of a therapy recommendation specifying relative amounts of the plurality of differing therapeutic agents to administer in combination with one another, wherein the optimization problem includes:
accounting for a dynamic molecular-level model that models 1) a cell population representing the one or more cell colonies, 2) differing components of one or more resistance-forming mechanisms of the one or more types of cells, and 3) effects that the differing therapeutic agents have on the differing components; and
accounting for a selective-pressure model configured to assess probabilities of inducing selective pressure on the cell population; and
a third set of machine-executable instructions for providing or applying the therapy recommendation to a user, wherein the therapy recommendation is based on the relative amounts of the plurality of differing therapeutic agents.

23. A machine-readable storage medium according to claim 22, wherein said accounting for the dynamic molecular-level model includes accounting for a model of a quorum sensing system for each of the one or more cell colonies.

24. A machine-readable storage medium according to claim 23, wherein said accounting for a model of a quorum sensing system for each of the one or more cell colonies includes accounting for a model of quorum sensing for a bacterial colony.

25. A machine-readable storage medium according to claim 24, wherein said accounting for the model of quorum sensing for the bacterial colony includes accounting for two types of bacterial strains belonging to the same species.

26. A machine-readable storage medium according to claim 25, wherein said accounting for the two types of bacterial strains belonging to the same species includes accounting for wild-types and signal-blind mutants.

27. A machine-readable storage medium according to claim 22, wherein said accounting for the dynamic molecular-level model includes deriving a single substrate growth model.

28. A machine-readable storage medium according to claim 27, wherein said deriving a single substrate growth model includes accounting for when the cells of the cell population are metabolically active but not growing or dividing.

29. A machine-readable storage medium according to claim 22, wherein said accounting for the dynamic molecular-level model includes accounting for production of an extracellular polymeric substance (EPS) produced by the one or more cell colonies.

30. A machine-readable storage medium according to claim 29, wherein said accounting for production of the EPS produced by the one or more cell colonies includes accounting for production of an EPS produced by one or more cancer cell colonies.

31. A machine-readable storage medium according to claim 22, wherein said accounting for the dynamic molecular-level model includes modeling communication between cells of at least one of the cell colonies of the one or more cell colonies.

32. A machine-readable storage medium according to claim 31, wherein said modeling communication (i.e., network) between cells of the at least one cell colony includes modeling signal molecules produced by cells within the at least one cell colony.

33. A machine-readable storage medium according to claim 32, wherein said modeling signal molecules produced by cells within the at least one cell colony includes accounting for properties of the signal molecules and for a extracellular physical diffusion limit.

34. A machine-readable storage medium according to claim 32, wherein said modeling signal molecules produced by cells within the at least one cell colony includes modeling signal molecules that do not have specific destinations encoded.

35. A machine-readable storage medium according to claim 22, wherein said accounting for the dynamic molecular-level model includes accounting for a diffusion-limited signal influence range.

36. A machine-readable storage medium according to claim 22, wherein said accounting for the dynamic molecular-level model includes accounting for a varied autoinducer signal influence range for particular cells within the one or more cell colonies.

37. A machine-readable storage medium according to claim 22, wherein said accounting for the dynamic molecular-level model includes accounting for a concentration of signal receptors for a cell within the one or more cell colonies.

38. A machine-readable storage medium according to claim 22, wherein said accounting for the dynamic molecular-level model includes modeling effects of a probiotic agent on the one or more cell colonies.

39. A machine-readable storage medium according to claim 22, wherein said accounting for a selective-pressure model includes accounting at least for selective pressures sourced from social behavior of the cell colony and individual regulation of a cell within the cell colony.

40. A machine-readable storage medium according to claim 39, wherein said accounting at least for selective pressures sourced from social behavior of the cell colony and individual regulation of a cell within the cell colony includes accounting for a growth advantage of a mutant cell within the cell colony.

41. A machine-readable storage medium according to claim 22, wherein said accounting for the dynamic molecular-level model includes accounting for virulence concentration.

42. A machine-readable storage medium according to claim 22, wherein said accounting for the dynamic molecular-level model includes accounting for the effect of individual quorum sensing inhibitors.
